(19) United States
(12) Patent Application Publication
(10) Pub. No.: US 2015/0006622 A1
(43) Pub. Date: Jan. 1, 2015

(54) WEB CONTENTS TRANSMISSION METHOD AND APPARATUS

(71) Applicants: Samsung Electronics Co., Ltd., Gyeonggi-do (KR); University-Industry Cooperation Group of Kyung Hee University, Gyeonggi-do (KR)

(72) Inventors: Hanna Lim, Seoul (KR); Sungwon Lee, Gyeonggi-do (KR); Jicheol Lee, Gyeonggi-do (KR); Hyungho Lee, Seoul (KR)

(21) Appl. No.: 14/321,664

(22) Filed: Jul. 1, 2014

(30) Foreign Application Priority Data
Jul. 1, 2013 (KR) 10-2013-0076572

(51) Int. Cl. H04L 29/08; H04L 29/06

(52) U.S. Cl. CPC H04L 67/02; H04L 67/42
USPC 709/203

(57) ABSTRACT

A web contents transmission method and apparatus is provided for improving user's perceived speed of web content transmission using Hyper Text Transfer Protocol (HTTP). The web contents transmission method includes receiving an HTTP Request (REQ) message from an HTTP client, transmitting the HTTP REQ message including an updated time information provision request for resource included in a template file of a domain, receiving an HTTP Response (RES) message corresponding to the HTTP REQ message from the HTTP server, the HTTP RES message including updated time information on at least one of the resources included in the template file of the domain, and processing a new HTTP REQ message from the HTTP client based on the update time information.

### CROSS-REFERENCE TO RELATED APPLICATION(S) AND CLAIM OF PRIORITY

The present application is related to and claims priority under 35 U.S.C. §119 to an application filed in the Korean Intellectual Property Office on Jul. 1, 2013 and assigned Serial No. 10-2013-0076572, the contents of which are incorporated herein by reference.

### TECHNICAL FIELD

The present disclosure relates to a web contents transmission method and apparatus and, in particular, to a method and apparatus for improving user's perceived speed of web content transmission using Hyper Text Transfer Protocol (HTTP).

### BACKGROUND

An HTTP client and an HTTP server can communicate directly without the use of cache information and can use a HTTP RES and REQ message in regular order. The transmission speed between the HTTP client and the HTTP server can seem slow. Content transmission speeds can be increased between the HTTP client and the HTTP client.

### SUMMARY

To address the above-discussed deficiencies, it is a primary object to provide a web contents transmission method and apparatus which is capable of improving user's perceived web content download speed.

In a first example, a web contents transmission method and apparatus that is capable of reducing the web content transmission delay with the involvement of an HTTP proxy server especially when the HTTP client requests the HTTP server for web contents using HTTP is provided.

In a second example, a web contents transmission method of a Hypertext Transfer Protocol (HTTP) proxy server is provided. The web contents transmission method includes receiving an HTTP Request (REQ) message from an HTTP client. The method also includes transmitting the HTTP REQ message including an updated time information provision request for resource included in a template file of a domain. The method further includes receiving an HTTP Response (RES) message corresponding to the HTTP REQ message from the HTTP server. The HTTP RES message includes updated time information on at least one of the resources included in the template file of the domain. The method includes processing a new HTTP REQ message from the HTTP client based on the update time information.

In a third example, a Hypertext Transfer Protocol (HTTP) proxy server is provided. The HTTP proxy server includes a communication unit configured to communicate with an HTTP client and HTTP server. The HTTP proxy server also includes a storage unit configured to store data transmitted/received by the communication unit. The HTTP proxy server further includes a control unit configured to control receiving an HTTP Request (REQ) message from an HTTP client. The control unit is also configured to transmit the HTTP REQ message including an updated time information provision request for resource included in a template file of a domain. The control unit is further configured to receive an HTTP Response (RES) message corresponding to the HTTP REQ message from the HTTP server. The HTTP RES message includes updated time information on at least one of the resources included in the template file of the domain. The control unit is configured to process a new HTTP REQ message from the HTTP client based on the update time information.

In a fourth example, a web contents transmission method of a Hypertext Transfer Protocol (HTTP) client is provided. The web contents transmission method of the HTTP client includes receiving an input of an HTTP resource request for a certain domain. The web contents transmission method of the HTTP client also includes transmitting an HTTP request (REQ) message including an updated time information provision request for resource included in a template file of the domain. The web contents transmission method of the HTTP client further includes receiving an HTTP Response (RES) message corresponding to the HTTP REQ message from the HTTP server. The HTTP RES message includes updated time information on at least one of the resources included in the template file of the domain. The web contents transmission method of the HTTP client includes processing a new HTTP resource request based on the updated time information.

In a fifth example, a Hypertext Transfer Protocol (HTTP) client is provided. The HTTP client includes a communication unit configured to communicate with at least one of an HTTP server and a HTTP proxy server. The communication unit is configured to control receiving an input of an HTTP resource request for a certain domain. The communication unit is also configured to transmit an HTTP request (REQ) message including an updated time information provision request for resource included in a template file of the domain. The communication unit is further configured to receive an HTTP Response (RES) message corresponding to the HTTP REQ message from the HTTP server. The HTTP RES message includes updated time information on at least one of the resources included in the template file of the domain. The communication unit is further configured to process a new HTTP resource request based on the updated time information.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is an example diagram illustrating the conventional HTTP Client/Server network architecture according to this disclosure;

FIG. 2 is an example signal flow diagram illustrating signals flows in the web content communication procedure in the conventional HTTP Client/Server network according to this disclosure;

FIG. 3 is an example diagram illustrating the conventional network structure made up of an HTTP client, an HTTP proxy server, and HTTP servers according to this disclosure;

FIG. 4 is an example block diagram illustrating a configuration of the proxy server of FIG. 3 according to this disclosure;

FIG. 5 is an example signal flow diagram illustrating signal flows between the HTTP server and the HTTP proxy server having cache information on the requested content according to this disclosure;

FIG. 6 is an example signal flow diagram illustrating signal flows among the conventional network nodes when the HTTP proxy server has not cache information according to this disclosure;

FIG. 7 is an example signal flow diagram illustrating signal flows among the network nodes which includes the operations of the conventional HTTP proxy server when the contents transmission delay is detected according to this disclosure;

FIG. 8A is an example block diagram illustrating a configuration of the HTTP proxy server according to this disclosure;

FIG. 8B is an example block diagram illustrating a configuration of the HTTP client according to this disclosure;

FIG. 9 is an example signal flow diagram illustrating the web contents transmission method according to this disclosure;

FIG. 10 is an example diagram illustrating HTTP session status transitions according to this disclosure;

FIG. 11 is an example diagram illustrating tables for explaining change of HTTP session information as shown in FIG. 9 according to this disclosure;

FIG. 12 is an example flowchart illustrating an HTTP REQ message handling procedure of the HTTP proxy server according to this disclosure;

FIG. 13 is an example flowchart illustrating an HTTP RES message handling procedure of the HTTP proxy server according to this disclosure;

FIG. 14 is an example signal flow diagram illustrating the web contents transmission method according to this disclosure;

FIG. 15 is an example diagram illustrating HTTP session status transitions according to this disclosure;

FIG. 16 is an example diagram illustrating tables for explaining change of HTTP session information as shown in FIG. 14 according to this disclosure;

FIG. 17 is an example flowchart illustrating the HTTP REQ message handling procedure of the HTTP proxy server according to this disclosure;

FIG. 18 is an example flowchart illustrating the HTTP RES message handling procedure of the HTTP proxy server according to this disclosure;

FIG. 19 is an example signal flow diagram illustrating the web contents transmission method according to this disclosure;

FIG. 20 is an example diagram illustrating a site address mapping table of the HTTP proxy server according to this disclosure;

FIG. 21 is an example flowchart illustrating the HTTP REQ message handling procedure of the HTTP proxy server according to this disclosure;

FIG. 22 is an example signal flow diagram illustrating the web contents transmission method according to this disclosure;

FIG. 23 is an example diagram illustrating a table providing final content access time information added to the HTTP REQ message according to this disclosure;

FIG. 24 is an example diagram illustrating a table providing final content update time information added to the HTTP RES message according to this disclosure;

FIG. 25 is an example flowchart illustrating the operation procedure of the HTTP client according to this disclosure;

FIG. 26 is an example flowchart illustrating the operation procedure of the HTTP proxy server according to this disclosure;

FIG. 27 is an example flowchart illustrating the operation procedure of the HTTP server according to this disclosure;

FIG. 28 is an example flowchart illustrating the HTTP RES message handling procedure of the HTTP proxy server according to this disclosure;

FIG. 29 is an example flowchart illustrating the HTTP RES message handling procedure of the HTTP client according to this disclosure;

FIG. 30 is an example signal flow diagram illustrating the procedure integrating the operations proposed in this disclosure; and

FIG. 31 is an example signal flow diagram illustrating the real time advertisement procedure according to this disclosure.

### DETAILED DESCRIPTION

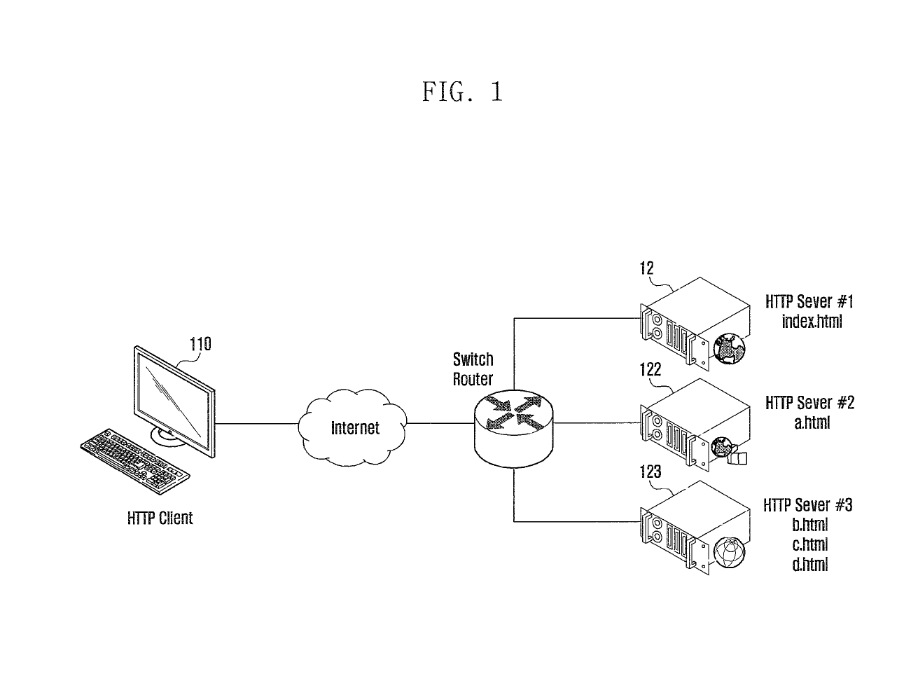

FIGS. 1 through 31, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication system. The terminology used herein is for the purpose of describing particular embodiments only and is not intended to be limiting of the disclosure. Unless otherwise defined, all terms used herein have the same meaning as commonly understood by one of ordinary skill in the art to which this disclosure pertains, and should be interpreted neither as having an excessively comprehensive meaning nor as having an excessively contracted meaning.

As used herein, the singular forms “a”, “an” and “the” are intended to include the plural forms as well, unless the context clearly indicates otherwise. It will be further understood that the terms “comprises” and “includes,” when used herein, should not be construed as including all of the components or operations specified in the present disclosure.

Exemplary embodiments of the present disclosure are described with reference to the accompanying drawings in detail.

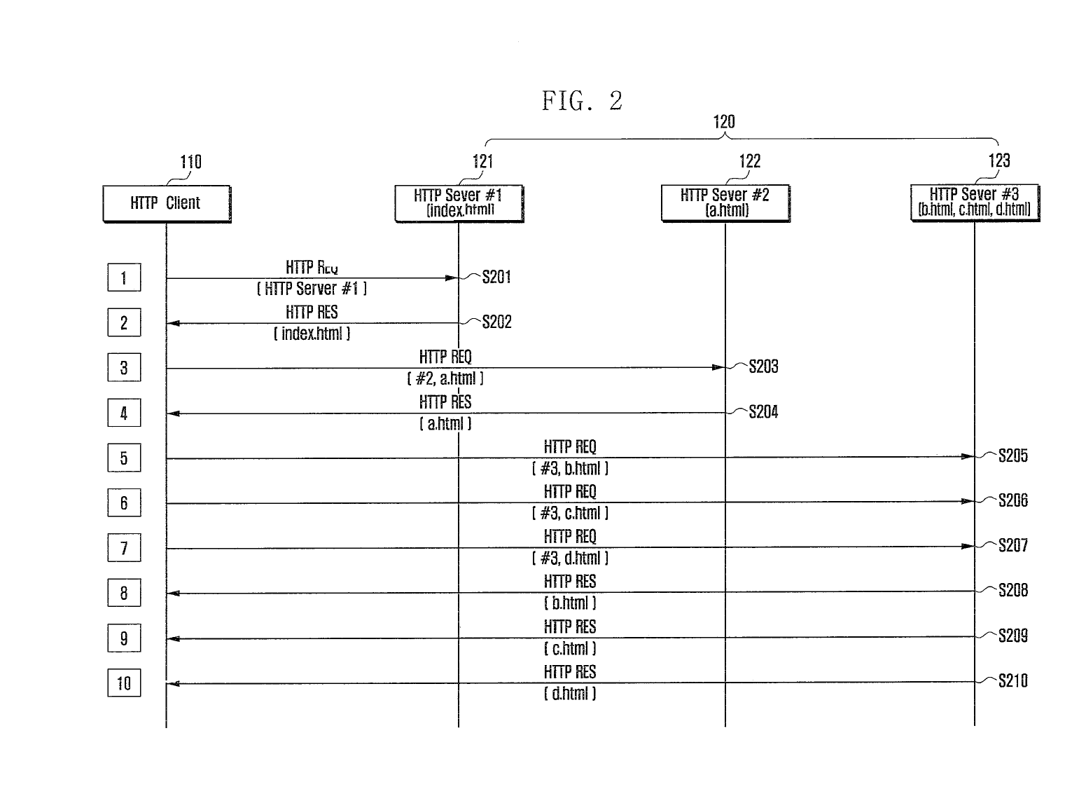

With the advance of network technology, recent electronic devices can be featured with web content utilization techniques. FIGS. 1 and 2 are drawings for explaining the conventional network technology for use of web contents. FIG. 1 is an example diagram illustrating the conventional HTTP Client/Server network architecture according to this disclosure, and FIG. 2 is an example signal flow diagram illustrating signals flows in the web content communication procedure in the conventional HTTP Client/Server network according to this disclosure. FIG. 1 shows an example of the network architecture of the conventional technology. FIG. 1 is directed to example of the structure for communicating web contents between HTTP Client and HTTP Servers.

Referring to FIG. 1, the network can include an HTTP client 110 attempting to access the web contents and HTTP servers 121, 122, and 123 providing the web contents (or services). The network nodes can be connected through wired/wireless communication links. The HTTP servers 121, 122, and 123 can store different contents and typically the HTTP client 110 can access the contents stored in the multiple servers to acquire an intended result by combining the contents. FIG. 2 shows an example operation scenario of the HTTP client 110 accessing the web contents in the conventional technology. In FIG. 2, the HTTP client 110 can send an HTTP request (HTTP REQ) message to the representative HTTP server 121 of the domain at sequence 1 (S201). Upon receipt of this message, the representative HTTP server 121 can send the HTTP client 110 a template (typically, index.html) file including the names of the resources and accessible Internet address for presenting a representative webpage of the domain at sequence 2 (S202). If the template file is received from the HTTP server #1 as the domain's representative server, the HTTP client 110 can check the respective resources indicated in the template files. The HTTP client 110 can request the HTTP server #2 122 for a.html at sequence 3 (S203) and bring the a.html from the from the HTTP server #2 122 at sequence 4 (S204). Afterward, the HTTP client 110 can request the HTTP server #3 123 for b.html, c.html, and d.html at sequences 5, 6, and 7 (S205, S206, and S207) and receive the b.html, c.html, and d.html in response to the respective requests at sequences 8, 9, and 10 (S208, S209, and S210). If the HTTP Response (HTTP RES) messages are received from the HTTP servers 120, the HTTP client 110 can display the corresponding contents immediately in order for the user to feel the receipt of the web contents and to check the display result immediately.

In the exemplary case of FIG. 1, however, the HTTP client 110 and the HTTP server 121, 122, and 123 can communicate directly without use of cache information and can use the HTTP RES and REQ messages in regular order and thus it feels that the perceived transmission speed of the web content is slow.

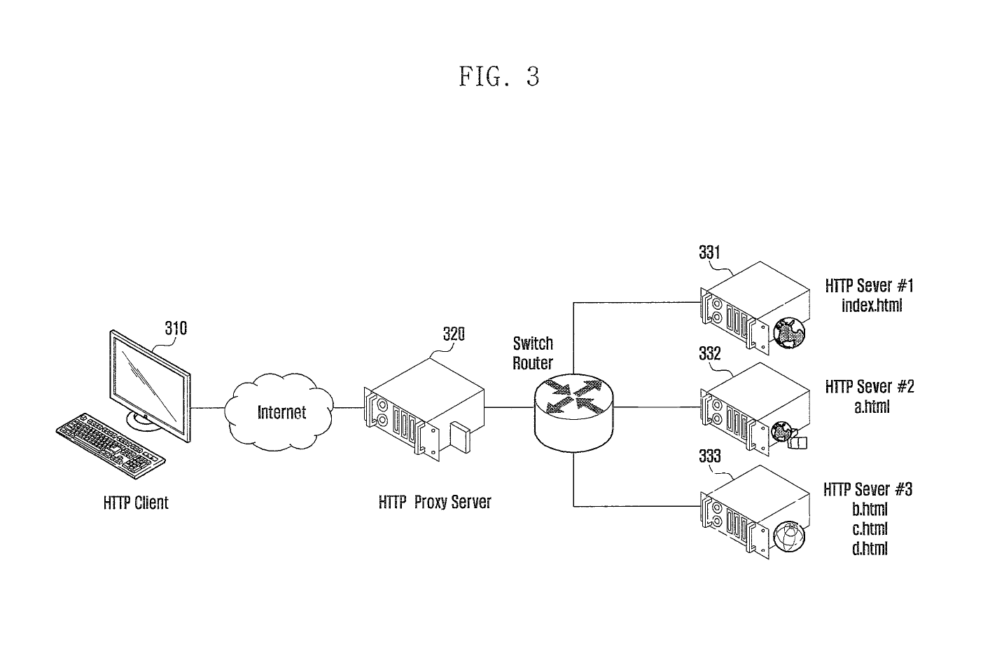

A description is made of a proxy server-based web contents transmission method with reference to FIGS. 3 to 7.

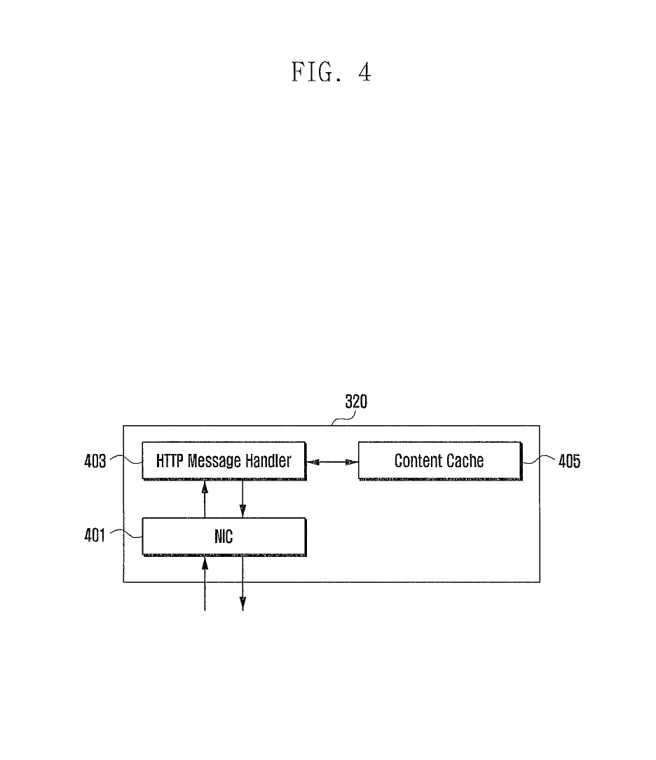

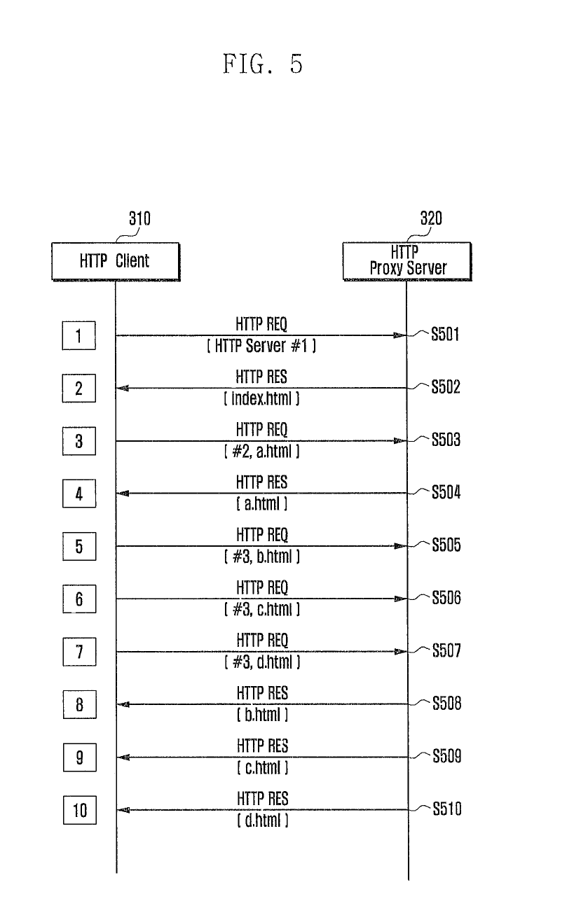

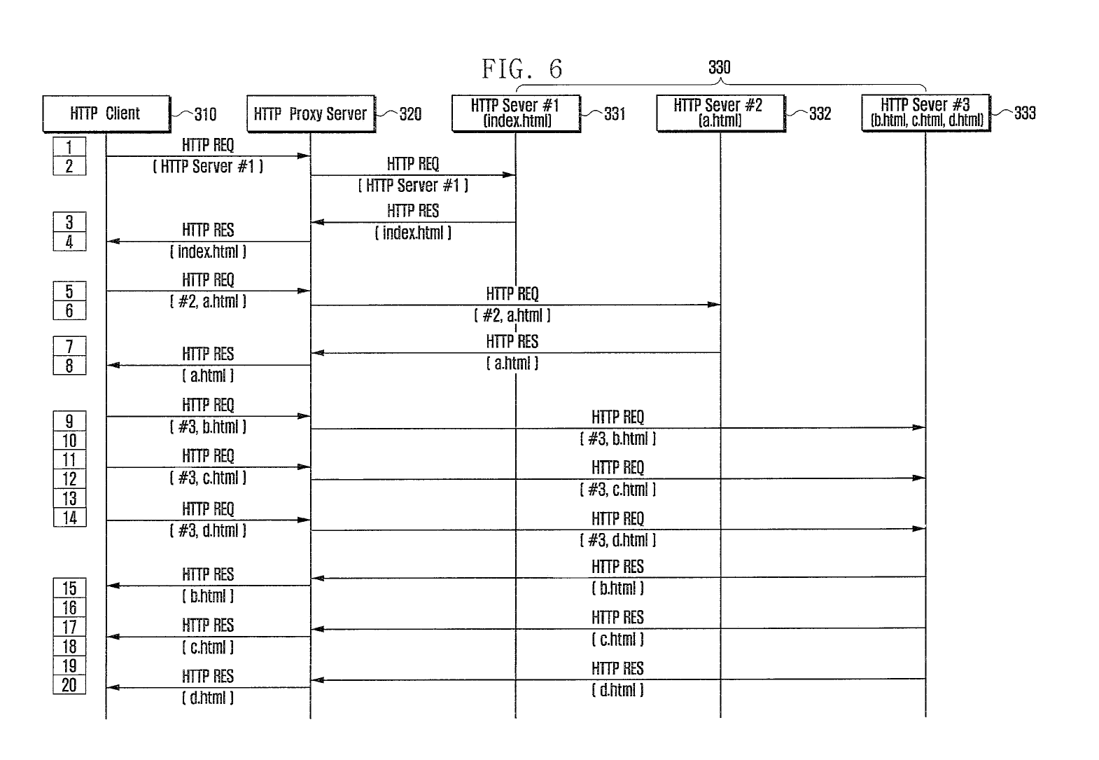

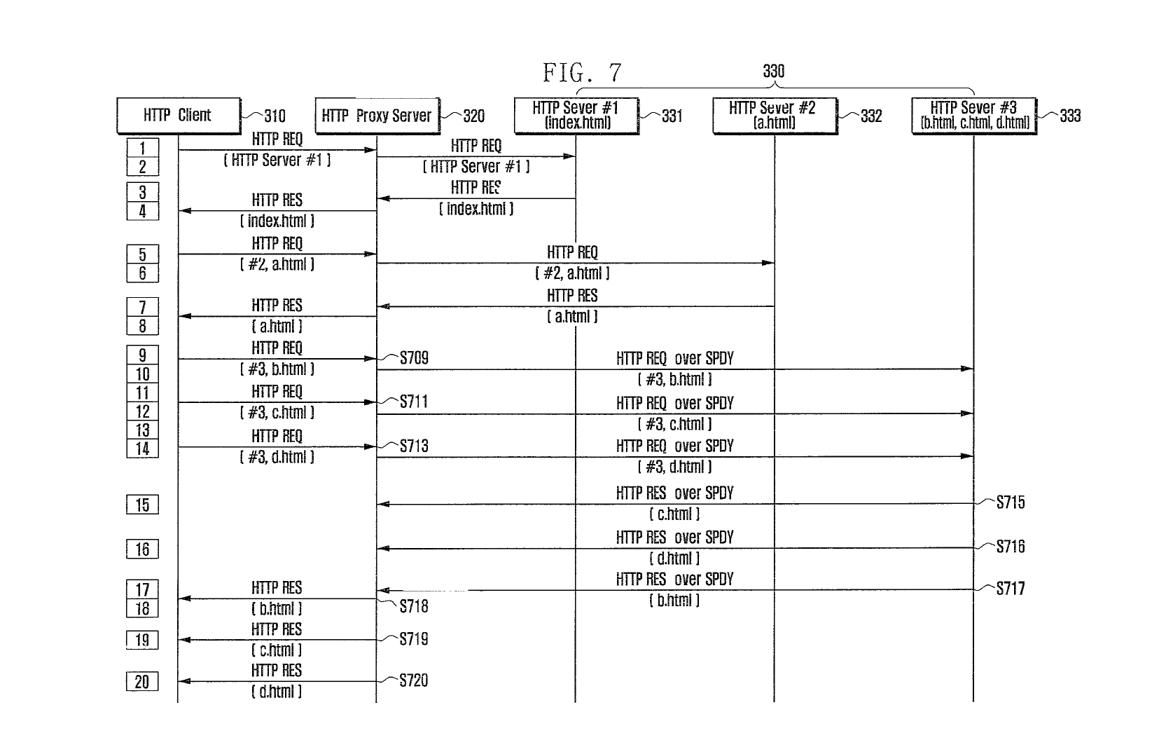

FIG. 3 is an example diagram illustrating the conventional network structure made up of an HTTP client, an HTTP proxy server, and HTTP servers according to this disclosure, FIG. 4 is an example block diagram illustrating a configuration of the proxy server of FIG. 3 according to this disclosure, FIG. 5 is an example signal flow diagram illustrating signal flows between the HTTP server and the HTTP proxy server having cache information on the requested content according to this disclosure, FIG. 6 is an example signal flow diagram illustrating signal flows among the conventional network nodes when the HTTP proxy server has not cache information according to this disclosure, and FIG. 7 is an example signal flow diagram illustrating signal flows among the network nodes which includes the operations of the conventional HTTP proxy server when the contents transmission delay is detected according to this disclosure.

FIG. 3 shows an example of the network structure in which the HTTP proxy server is interposed between the HTTP client and the HTTP servers to reduce the transmission delay and network load in association with the web content access of the HTTP client according to this disclosure.

In the case of being made up of the HTTP client 310, the HTTP servers 330, 331, 332, and 333, and the HTTP proxy server 320, the HTTP proxy server 320 can be interposed between the HTTP client 310 and the HTTP servers 330. The HTTP proxy server 320 can have the caches of contents stored in the HTTP servers 330 and can deliver the cached content in response to the HTTP client 310 immediately to reduce response time. In order to accomplish this, the HTTP proxy server 320 can have an HTTP message handler 403 for analyzing the HTTP message exchanged between the HTTP client 310 and the HTTP servers 330 in the Network Interface Card (NIC) 401 for communication and a content cache 405 for caching the HTTP contents provided by the HTTP servers 330, as shown in FIG. 4.

FIG. 5 is an example directed to the signal flows between the HTTP client 310 and the HTTP proxy server 320 when all the contents requested by the HTTP client 310 are cached in the HTTP proxy server 320 according to this disclosure. The HTTP requests (HTTP REQs) transmitted by the HTTP client 310 at operations S501, S503, S505, S507, and S509 can arrive at the HTTP proxy servers without delivered to the HTTP servers 330 The HTTP proxy server 320 can transmit the cached contents to the HTTP client 310 at operations S502, S504, S506, S508, and S510 in response to the respective requests.

In at least the case that the contents requested by the HTTP client 310 are absent in the HTTP proxy server 320, the HTTP proxy server 320 can relay the HTTP REQ messages to the HTTP servers 330 and relay the HTTP RES messages transmitted by the HTTP servers 330 to the HTTP clients 310. In this case, there may be no conspicuous performance enhancement as compared to the conventional method FIG. 2 because there can be an advantage of using the cache information stored in HTTP proxy server 320.

In the case of using the HTTP proxy server 320 as shown in FIG. 4, if the HTTP client 310 can perform HTTP communication with the HTTP proxy server 320 on the Transmission Control Protocol (TCP) and if the HTTP proxy server 320 and the HTTP servers 330 can communicate using a new transmission protocol such as SPDY, it can be difficult to expect the improvement in content delivery speed. This is described in detail with reference to FIG. 7. In FIG. 7, if the HTTP client 310 can send the HTTP proxy server 320 the HTTP REQ messages at sequences 9, 11, and 13 (S709, S711, and S713), the HTTP client 310 can receive the HTTP RES messages from the HTTP proxy server 320 in the requested order of (b.html→c.html→d.html) in case of using the conventional HTTP. Accordingly, if the b.html which has been requested at sequence 9 (S709) arrives after the receipt of the c.html and d.html which have been requested at sequences 11 and 13 (S711 and S713) as denoted by reference numbers S715, S716, and S717, this can cause a problem. The HTTP proxy server 320 can retain the c.html and d.html arrived earlier before the HTTP RES transmitted by the HTTP server 330 at sequence 17 (S717) as a reply to the HTTP REQ message transmitted at sequence 9 (S709) arrives at the HTTP proxy server 320. If the b.html arrives at the HTTP proxy server 320, the HTTP proxy server 320 can transmit b.html, c.html, and d.html in the order of sequences 18, 19, and 20 (S718, 719, and 720) to the HTTP client 310 in correspondence to the order of sequences 9, 11, and 13 (S709, S711, and S713). Since the HTTP RES messages can be received in the same order as HTTP REQ messages, this can retard the contents transmission speed. The web contents transmission method according to the embodiments of FIGS. 3 to 7 can improve the contents transmission speed as compared to the contents transmission method of FIGS. 1 and 2. However, if the contents requested by the HTTP client are absent in the HTTP proxy server, there may be no conspicuous gain as compared to the method of FIGS. 1 and 2. In the case of accessing multiple contents stored in a specific server, if the HTTP RES messages arrives in an order different from the transmission order of corresponding HTTP REQ messages, the HTTP RES messages corresponding to the HTTP REQ messages following the HTTP REQ message of which corresponding HTTP RES message has not received may not be delivered to the HTTP client although they have arrived earlier. Such HTTP RES messages may not be delivered immediately but can wait for the receipt of the HTTP RES message in response to the preceding HTTP REQ message.

A description is made of the web contents transmission method and apparatus capable of correcting the shortcomings of the embodiment of FIGS. 3 to 7 using an enhanced HTTP proxy server hereinafter.

A first embodiment of the present disclosure is directed to a method of improving the web contents transmission speed for example when the HTTP RES message reception is delayed in response to the preceding HTTP REQ message of the embodiment of FIGS. 3 to 7. In an embodiment, if the HTTP RES message corresponding to the preceding HTTP REQ message arrives later than the HTTP RES message corresponding to the following HTTP REQ message, the HTTP proxy server can send the HTTP client the dummy HTTP RES message corresponding to the preceding HTTP REQ message such that the HTTP RES messages corresponding to the preceding HTTP REQ message are delivered to the HTTP client without delay, resulting in improvement of the user's perceived speed. The real HTTP RES message corresponding to the preceding HTTP REQ message can be delivered to the HTTP client immediately upon receipt from the HTTP proxy server such that the HTTP client can replace the dummy HTTP RES message with the real HTTP RES message.

A second embodiment of the present disclosure is directed to a method appropriate for wireless data communication in which the transmission speed between the HTTP client and HTTP proxy server can be variable and which can have a large delay or home wideband wired communication to solve the shortcoming of the embodiment of FIGS. 3 to 7. That is, the HTTP proxy server can relay the HTTP REQ message from the HTTP client to the HTTP server and then can deliver a template file as a response from the HTTP server to the HTTP client. The HTTP proxy server can request the HTTP server (s) for the resources of the template file in the stead of the HTTP client as well as send the HTTP client the corresponding HTTP RES message. If the communication speed between the HTTP proxy server and the HTTP server is a few folds faster than that between the HTTP client and the HTTP proxy server, it is possible for the HTTP proxy server to secure the resources of the template quickly. Afterward, if the HTTP client sends the HTTP REQ messages for the template, the HTTP proxy server can transmit the contents stored in advance to the HTTP client in the stead of the HTTP servers, resulting in improvement of user's perceived speed.

A third embodiment of the present disclosure is an extension of the method of the second embodiment. The third embodiment of the present disclosure is directed to a method of deceiving the HTTP client as if a resource address of a specific server is of the resource of a plurality of servers logically to solve the problem caused by receiving the HTTP RES messages in an order different from the transmission order of the corresponding HTTP REQ message when the HTTP client connects to the HTTP servers indicated in the template. The HTTP proxy server can deceive the HTTP client as if the N resources belonging to one server are the resources belonging to (up to) N servers respectively from the view point of the HTTP client so as to reduce the resource access time delay.

Another embodiment of the present disclosure is directed to determining whether the contents cached in the course of performing the sequences of FIG. 6 are valid when the HTTP client and the HTTP proxy server have caches. That is, the HTTP client and the HTTP proxy server can determine whether their caches are available by checking the updated time through exchange of HTTP commands per resource indicated in the template. In at least the fourth embodiment of the present disclosure, the template can be extended for the HTTP client and the HTTP proxy server to receive the information on the availability per resource from the HTTP servers so as to reduce unnecessary message exchange, resulting in improvement of user's perceived speed.

Detailed descriptions are made of at least the first to fourth embodiments hereinafter. The techniques proposed can be applicable independently. Also, the proposed techniques can be provided simultaneously in a combined manner.

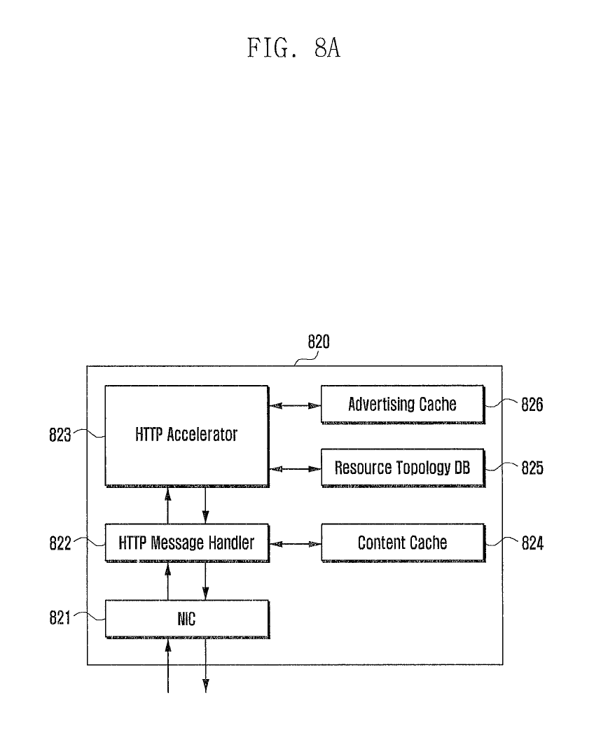

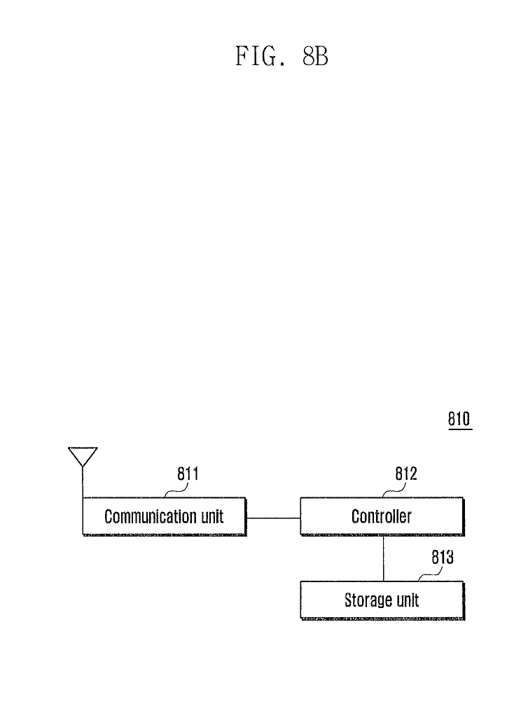

A description is made of the improved HTTP proxy server 820 applicable to the respective embodiments with reference to FIG. 8A.

Referring to FIG. 8A, the HTTP proxy server 820 can include a Network Interface Card (NIC) 821, an HTTP message handler 822, an HTTP accelerator 823, and a content cache 824.

The NIC 821 can transmit and receive information to and from the HTTP client 810 and/or the HTTP server 830 through at least one network channel. The HTTP message handler 822 can analyze the HTTP messages exchanged between the HTTP client 810 and the HTTP server 830. The content cache 824 can store the web content information transmitted by the HTTP client 810 and/or the HTTP server 830. The content cache 824 can store the contents temporarily. The HTTP accelerator 823 can perform the operations for increasing the HTTP web content delivery speed.

The HTTP proxy server 820 can further include a resource topology database 825 and an advertising cache 826. The resource topology database 825 can store the topology information of resources forming the HTTP contents for the HTTP accelerator 823 to improve the user's perceived transmission speed. The advertising cache 826 can provide the user with advertisement in transmitting dummy web contents. The operator managing the HTTP proxy server 820 with the advertising cache 826 can promote the profit.

FIG. 8A is an example block diagram illustrating a configuration of the HTTP proxy server 820 according to this disclosure. Although the description is made with the separated blocks for explanation convenience, the configuration of the HTTP proxy server 820 is not limited to FIG. 8A. That is, the HTTP proxy server 820 can include a control unit for controlling the NIC 821, the HTTP message handler 822, the HTTP accelerator 823, and the content cache 824. The HTTP proxy server 820 can include a communication unit for communication with the HTTP client 810 and the HTTP server and a storage unit for storing data necessary for the operation of the HTTP proxy server and cache data. The NIC 821 can be included in the communication unit. The content cache 824 can be included in the storage unit.

In more detail, the control unit can control receiving an HTTP REQ message from the HTTP client, transmitting to the HTTP server the HTTP request message including a request for providing update time information on the resources included in the template file of the domain, receiving an HTTP RES message including the update time information on the at least one of the resources included in the template of the domain, and processing a new HTTP REQ message from the HTTP client.

If the resource stored in the cache can be reused as the resource requested through the new HTTP REQ message based on the update time information, the control unit can control transmitting the resource stored in the cache to the HTTP client and, otherwise if the resource requested by means of the HTTP REQ message cannot be reused or is not stored in the cache, requesting the HTTP server for the information on the corresponding resource and transmitting the information to the HTTP client.

The control unit can determine whether to reuse the stored resource. In order to determine whether to reuse the stored resource, the control unit can compare the final update time of the resource included in the HTTP RES message and the time when the resource has been stored in the cache finally before the request for the new HTTP REQ message so as to determine, when the final cache storage time is later, the resource can be reused.

If the received HTTP REQ message is the message requesting for the template file of the domain, the control unit can determine whether the time update information is necessary and, if so, can control to transmit the HTTP REQ message including the update time information provision request message.

If the resource on the domain is not stored in the cache and if no domain resource update time provision request is included in the HTTP request message received from the HTTP client, the control unit can determine that the time update information is necessary.

The description can be directed to the operation of the control unit of the HTTP proxy server in at least the fourth embodiment of the present disclosure. However, the operation of the control unit may not be limited to the above description but the HTTP proxy server 820 can be the host of controlling the operations in the first to fourth embodiments.

FIG. 8B is an example block diagram illustrating a configuration of the HTTP client according to this disclosure.

Referring to FIG. 8B, the HTTP client 810 can include a communication unit 811, a control unit 812, and a storage unit 813. The communication unit 811 can be responsible for data communication with the HTTP proxy server 820 and/or the HTTP server. The control unit 812 can control the overall operations of the components of the HTTP client 810. The storage unit can store the data necessary for the operation of the HTTP client and transmitted and received through the communication unit 811.

The function of the control unit 812 is described in more detail. In an embodiment, the control unit 812 can control receiving an input requesting for HTTP resource of a specific domain, transmitting an HTTP REQ message including the update time information provision request for the resource included in the template file of the domain, receiving an HTTP RES message corresponding to the HTTP request message and including the update time information on at least one of the resources included in the template file of the domain from the HTTP server, and processing a new HTTP resource request based on the update time information.

If it is possible to reuse the resource stored in the cache in response to the new HTTP resource request input based on the update time information, the control unit 812 can control to use the resource stored in the cache immediately and, otherwise if it is impossible to reuse the resource indicated by the new HTTP resource request input or if the resource is not stored in the cache, to request the HTTP server or the HTTP proxy server for the information on the corresponding resource and receive the corresponding resource.

The control unit 812 can compare the final update time of the resource included in the HTTP RES message and the time when the resource has been stored in the cache finally before the request for the new HTTP resource request message so as to determine, when the final cache storage time is later, that resource can be reused.

The description has been directed to the operation of the controller 812 of the HTTP client in at least the fourth embodiment of the present disclosure. However, the operation of the control unit 812 may not be limited to the above description but the HTTP client 810 can be the host of controlling the operations in at least the first to fourth embodiments.

A description is made of the web contents transmission method for improving the web contents transmission speed in detail with reference to accompanying drawings.

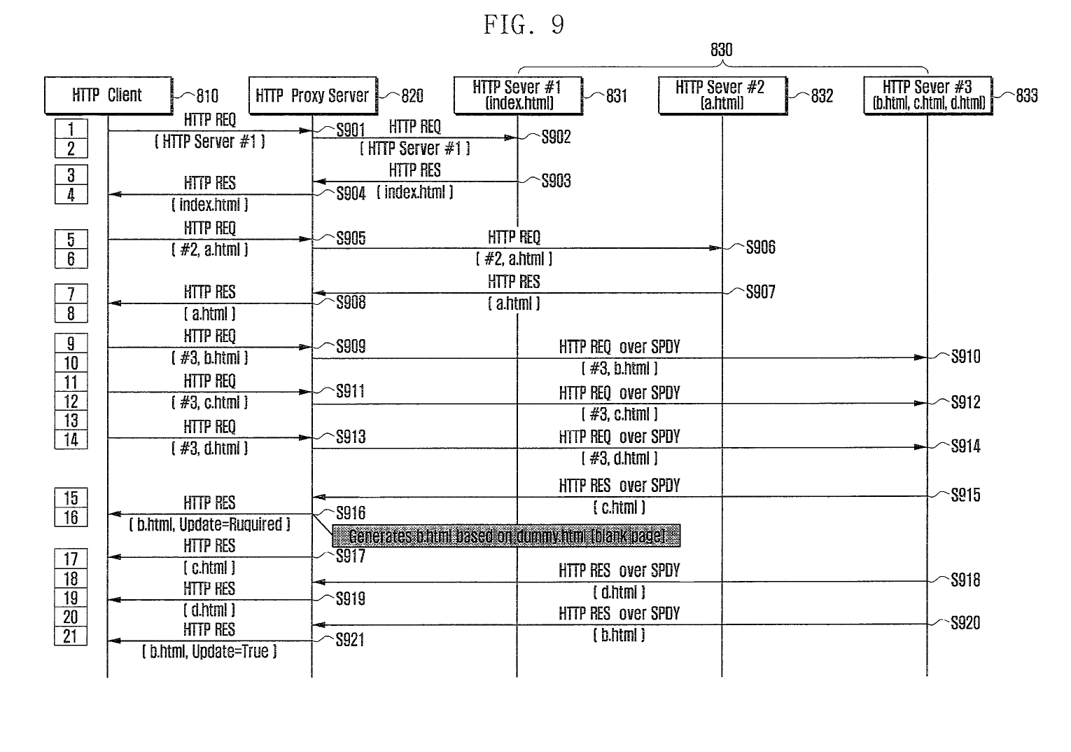

First, the first embodiment of the present disclosure is described with reference to FIG. 9. In the first embodiment, if the HTTP RES message corresponding to the preceding HTTP REQ message is delayed, the HTTP proxy server can send the HTTP client a dummy HTTP RES message. In this way, the following HTTP RES messages can arrive at the HTTP client without delay to improve the user's perceived speed. If the HTTP RES message transmitted by the HTTP server arrives at the HTTP proxy server, the HTTP proxy server can forward the HTTP RES message to the HTTP client to replace the dummy HTTP RES message with the real HTTP RES message.

FIG. 9 is an example signal flow diagram illustrating the web contents transmission method according to this disclosure. For example, FIG. 9 can also relate to at least the first embodiment. The HTTP client 810 can send the HTTP proxy server 820 an HTTP REQ message to access an intended content at sequence 1 (S901). The HTTP proxy server 820 can forward the HTTP REQ message received from the HTTP client 910 to a representative HTTP server (HTTP server #1) 831 of the HTTP client domain at sequence 2 (S902). Upon receipt of the HTTP request message, the representative HTTP server 831 can send the HTTP proxy server 820 a template (typically, index.html) file including the names of the resources forming the representative web page of the domain and an accessible Inter address at sequence 3 (S903). Upon receipt of the template file, the HTTP proxy server 820 can forward the template file to the HTTP client 810 at sequence 4 (S904). If the template file is received from the HTTP server #1 831 as the representative HTTP server of the domain, the HTTP client 810 can access the resources forming the template files. The HTTP client 810 can bring a.html from the HTTP server #2 832 through sequences 5 to 8 (S905, S906, S907, S908). The HTTP client 810 can requests the HTTP proxy server 820 for b.html, c.html, and d.html through sequences 9, 11, and 13 (S909, S911, and S913). The HTTP Proxy server 820 can requests the HTTP server #3 for b.html, c.html, and d.html through sequences 10, 12, and 14 (S910, S912, and S914). The HTTP proxy server 820 can receive the b.html, c.html, and d.html from the HTTP server #3 in response to the requests at sequences 10, 12, and 14. The HTTP proxy server 820 can receive the resource responses corresponding to the resource requests in a mismatched order.

The HTTP proxy server 820 can receive the c.html at sequence (S915). The HTTP proxy server 820 can receive the c.html corresponding to the following resource request made at sequence 9 prior to the b.html corresponding to the preceding resource request made at sequence 11. In at least the first embodiment, it is possible to resolve the delay problem occurring in the conventional method and the above described embodiment when the b.html requested at sequence 9 arrives before the c.html requested at sequence 11, resulting in improvement of the user's perceived speed. The HTTP proxy server 820 can send the HTTP client 810 the fake (or dummy) web content instead of the b.html in delay. After transmitting the dummy web content, the HTTP proxy server 820 can forward the c.html received right before to the HTTP client 810 immediately at sequence 17 (S917) such that the user can check the previously received resources to maintain the corresponding web content server, resulting in improvement of user's perceived speed. Likewise, if the d.html arrives before the b.html at sequence 18 (S918), the HTTP proxy server 820 can forward the d.html to the HTTP client with delay such that the user can check the received resource immediately, resulting in improvement of the user's perceived speed (S919). Finally, if the b.html arrives at the HTTP proxy server 820 at sequence 20 (S920), the HTTP proxy server 820 can forward the real response to the HTTP client 810 at sequence 21 (S921). In at least this embodiment, if the response corresponding to the following resource request arrives earlier than the response corresponding to the preceding resource request, the HTTP proxy server can send a dummy response corresponding to the preceding resource request other than suspending the delivery of the response corresponding to the following resource request such that the user is aware of the continuous receipt of the web contents and checks the reception result immediately.

In at least the first embodiment of the present disclosure, the HTTP proxy server 820 can sends the HTTP client the HTTP RES message including extra information at sequences 16 and 21 (S916 and S921) in FIG. 9. That is, the HTTP RES message can include an update field which is set to ‘required’ indicating that the HTTP RES message is the dummy HTTP RES message transmitted due to the arrival of the following message before the real HTTP RES message, and set to ‘True’ instructing to update the dummy HTTP RES with the real HTTP RES message.

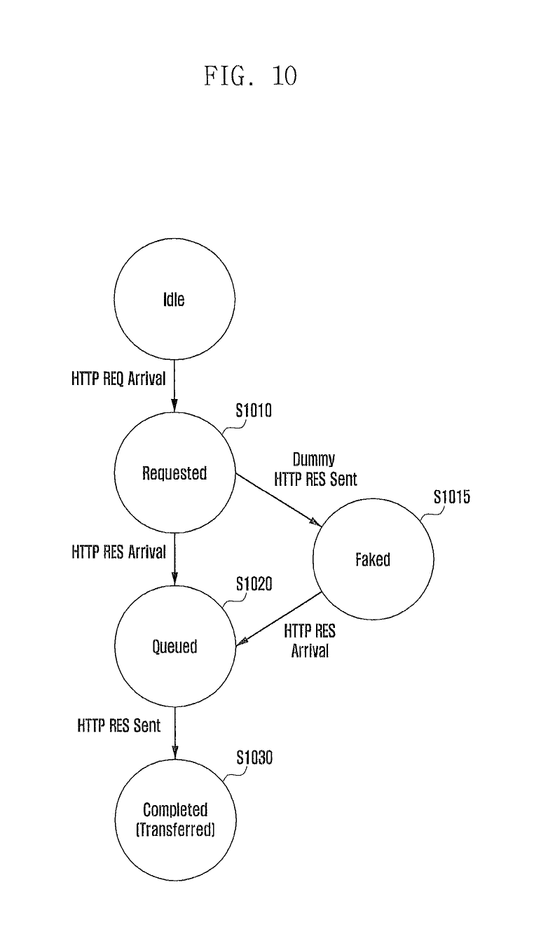

At least the first embodiment of the present disclosure is described in more detail hereinafter with reference to FIGS. 10 to 13. FIG. 10 is an example diagram illustrating HTTP session status transitions according to at least the first embodiment of this disclosure.

An embodiment of the present disclosure can propose the HTTP session statuses as follows: Requested S1010, Queued S1020, Faked S1015, and Completed S1030.

The HTTP proxy server 820 can perform status management for the HTTP REQ/RES session in progress. Each session can transition among different statuses as shown in FIG. 10. If an initial HTTP REQ message is detected, the HTTP proxy server 820 can define that the corresponding session is in ‘requested’ status. If the real HTTP RES message is received afterward, the HTTP proxy server 820 can store the message in the transmission buffer toward the HTTP client 810 and can transition the session from the ‘requested’ status to the ‘queued’ status. The message stored in the transmission buffer can be sent to the HTTP client by means of the HTTP message handler 822 and, at this time, the corresponding session can transition to the ‘completed’ status to indicate that the HTTP REQ/RES session is terminated. In at least the case that a response corresponding to the request made later than the session in the ‘requested’ status arrives earlier, dummy web content information can be sent to the HTTP client in response to the HTTP REQ message of which real responses is delayed and the session can transition to the ‘faked’ status. If the real HTTP RES message is received, the session can transition to the ‘queued’ status.

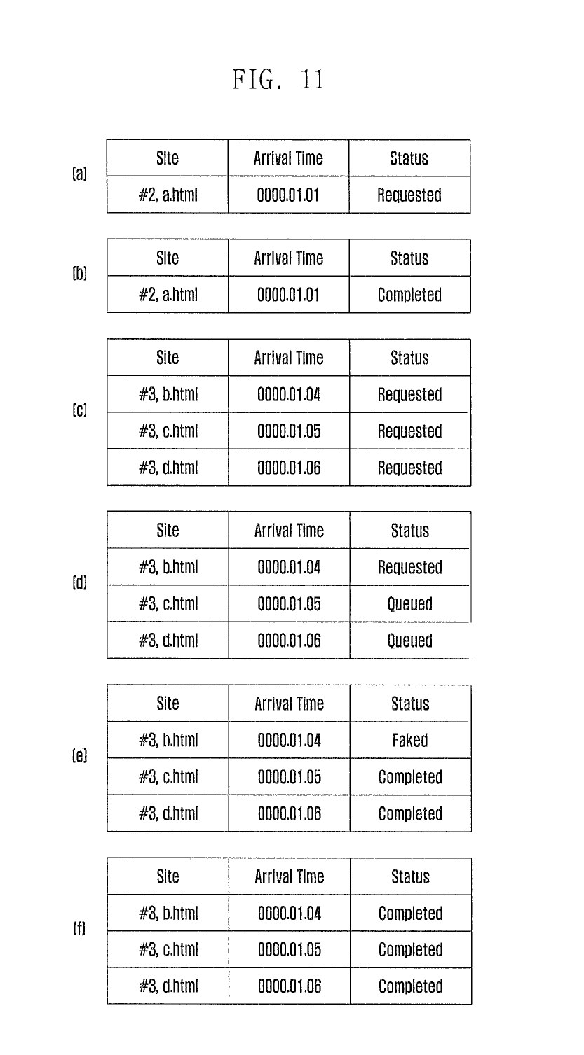

A description is made of the exemplary HTTP session information management of the HTTP proxy server 820 with reference to FIGS. 9 and 11. FIG. 11 is an example diagram illustrating tables for explaining change of HTTP session information in the embodiment of FIG. 9. In the following, the description is made with reference to the sequences of FIG. 9 and session statuses and records of FIG. 11. If the HTTP REQ message is received at sequence 1 (S901) of FIG. 9, a record can be generated as shown in part (a) of FIG. 11. The term ‘site’ can denote the resource corresponding to the session, and the term ‘arrival time’ can denote the time of arrival of the HTTP REQ message for the corresponding request at the HTTP proxy server. The status can indicate ‘requested’ due to the receipt of the HTTP REQ message. If the HTTP RES message is delivered completely at sequence 4 (S904) of FIG. 9, the status of part (a) of FIG. 11 can be changed to ‘completed’ as shown in part (b) of FIG. 11. Likewise, if the HTTP proxy server 820 requests for b.html, c.html, and d.html stored in the HTTP server #3 833 as in the scenario of FIG. 9, the corresponding HTTP REQ messages can be registered with the HTTP proxy server 820 as shown in part (c) of FIG. 11. Afterward, if the c.html and d.html arrive, the corresponding session information can be changed as shown in part (d) of FIG. 11. Accordingly, in order to deliver the c.html and d.html as early as possible, the HTTP proxy server 820 can transmit dummy information, instead of the delayed b.html, to the HTTP client 810 with the update of the session information as shown in part (e) of FIG. 11. Finally, if the real b.html arrives at the HTTP proxy server 820, the HTTP proxy server 820 can forward the b.html to the HTTP client 810 with the update of the session information as shown in part (f) of FIG. 11.

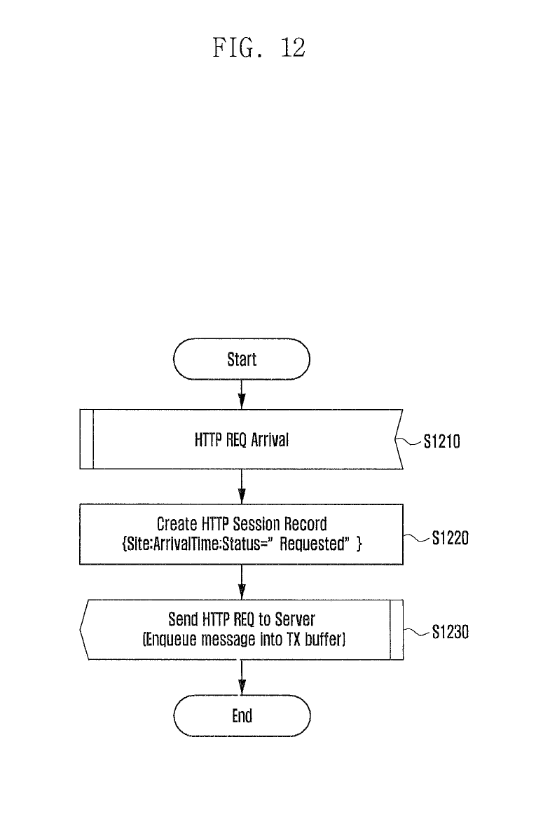

FIG. 12 is an example flowchart illustrating an HTTP REQ message handling procedure of the HTTP proxy server according to at least the first embodiment of this disclosure.

If the HTTP REQ message is received from the HTTP client 810, the HTTP proxy server 820 can operate as shown in FIG. 12. The HTTP proxy server 820 can receive the HTTP REQ message from the HTTP client 810 at operation S1210. Next, the HTTP proxy server 820 can generate an HTTP session record at operation S1220. Next, the HTTP proxy server 820 can store the HTTP REQ in the transmission buffer toward the HTTP server at operation S1230.

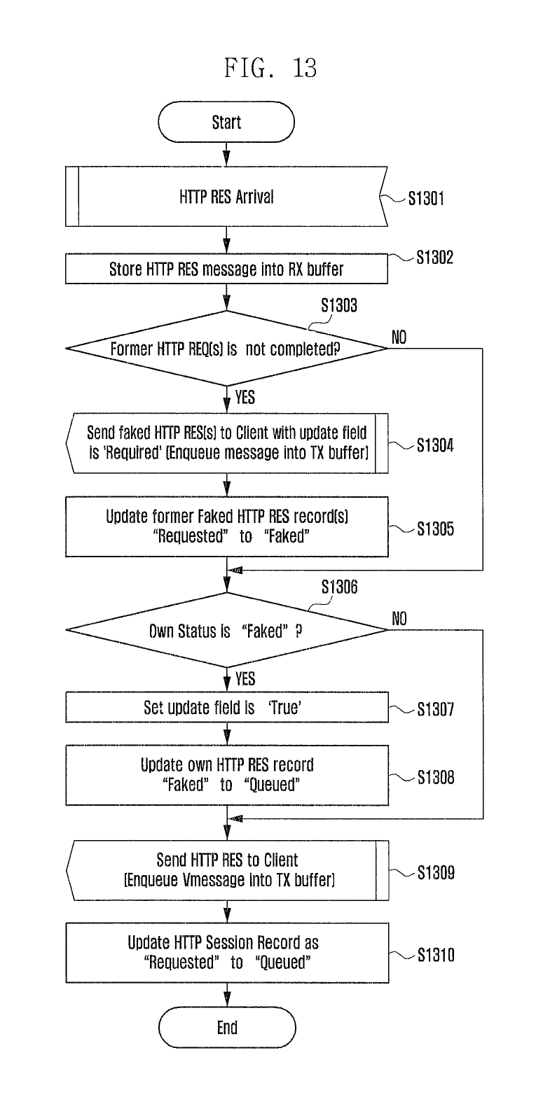

FIG. 13 is an example flowchart illustrating an HTTP RES message handling procedure of the HTTP proxy server according to at least the first embodiment of this disclosure.

If the HTTP RES message is received from the HTTP server 830, the HTTP proxy server 820 can operate as shown in FIG. 13. If the HTTP RES message is received at operation S1301, the HTTP proxy server 820 can store the received message in the buffer at operation S1302. Next, the HTTP proxy server 820 can determine whether there is any missing HTTP RES message with priority as compared to the HTTP RES messages received already at operation S1303. If there is any mission HTTP RES message with priority, the HTTP proxy server 820 can generate dummy information and send the HTTP client 810 the dummy HTTP RES message at operation S1304 and can transition the corresponding dummy information transmission HTTP session to ‘faked’ status at operation S1305. At this time, the update filed of the HTTP RES message including the dummy information can be set to ‘required.’ If the HTTP session status in which the current HTTP RES message is received is set to ‘faked,’ at operation S1306, this can mean that the HTTP RES message is delayed and thus the dummy HTTP RES message is transmitted to the HTTP client 810 and thus the HTTP proxy server 820 can set the update field to ‘true’ in the HTTP RES message transmitted to the HTTP client 810 at operation S1307. Afterward, the HTTP proxy server 820 can transition the HTTP session status to the ‘queued’ at operation S1308. The HTTP proxy server 820 sends HTTP RES to Client 810 at operation s1309. The HTTP proxy server 820 updates HTTP session record as requested to queued at operation s1310.

The second embodiment of the present disclosure is described hereinafter. The second embodiment proposes a method appropriate for wireless data communication in which the data rate between the HTTP client 810 and HTTP proxy server 820 is variable and which has relatively large delay or home wideband wired communication. The HTTP proxy server 830 which has checked the delivery of the template file from the HTTP server 830 to the HTTP client 810 after the transmission of the HTTP REQ message from the HTTP client 810 to the HTTP server 830 can request the HTTP servers 830 for the resources forming the template file in the stead of the HTTP client 810 as well as forward the HTTP RES message to the HTTP client 810. If the communication speed between the HTTP proxy server 820 and the HTTP server 830 is a few folds faster than that between the HTTP client 810 and the HTTP proxy server 820, it is possible for the HTTP proxy server 820 to secure the resources of the template quickly.

Afterward, if the HTTP client 810 can send the HTTP REQ messages for the template, the HTTP proxy server 820 can transmit the contents stored in advance to the HTTP client in the stead of the HTTP servers 830, resulting in improvement of user's perceived speed.

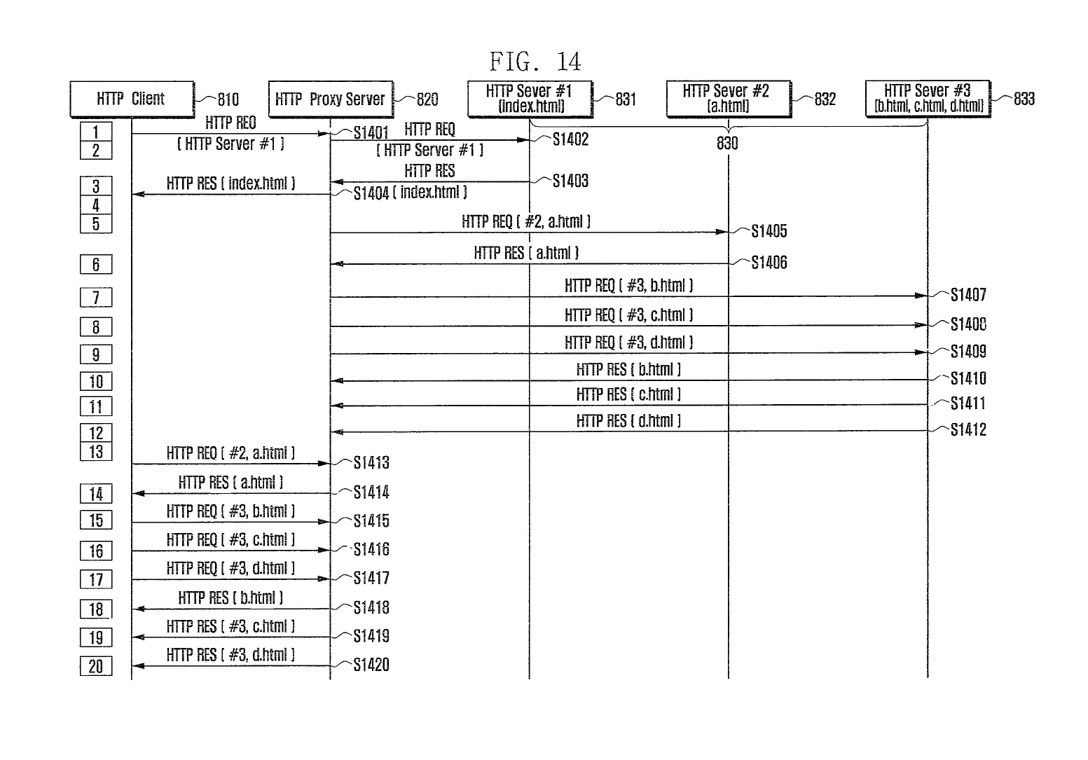

The second embodiment of the present disclosure is described hereinafter in more detail with reference to accompanying drawings. FIG. 14 is an example signal flow diagram illustrating the web contents transmission method according to at least the second embodiment of this disclosure.

The HTTP client 810 can send an HTTP REQ message to the HTTP server #1 as the representative server of the domain at sequences (S1401). The HTTP proxy server 820 can intercept the HTTP REQ message, determine that the information on the HTTP server #1 does not exist in its cache, and forward the HTTP request to the HTTP server #1 831 at sequence 2 (S1402). If an HTTP RES message is received at sequence 3 (S1403) in response to the HTTP REQ message, the HTTP proxy server 820 can forward the HTTP RES message to the HTTP client 810 as well as storing the index.html file as the corresponding template file at sequence 4 (S1404).

The second embodiment of the present disclosure can be characterized in that the contents which the HTTP client 810 intends to access are retained in the HTTP proxy server 820 in advance to reduce the resource access time delay of the HTTP client 810. Accordingly, the HTTP proxy server 820 can access the HTTP servers 830 to secure the resources forming the template at sequences 5, 7, 8, and 9 (S1405, S1407, S1408, and S1509). In an embodiment, if all the resources are secured in response to the HTTP REQ messages at sequences 6, 10, 11, and 21 (S1406, S1410, S1411, and S1412) before receipt of the initial HTTP REQ message at sequence 13 (S1413), the HTTP REQ messages transmitted at sequences 13, 15, 16, and 17 (S1413, S1415, S1416, and S1417) can be delivered to the HTTP servers 830, and the HTTP proxy server 820 can send the HTTP client 810 the HTTP RES messages at sequences 14, 18, 19, and 20 (S1414, S1418, S1419, and S1420).

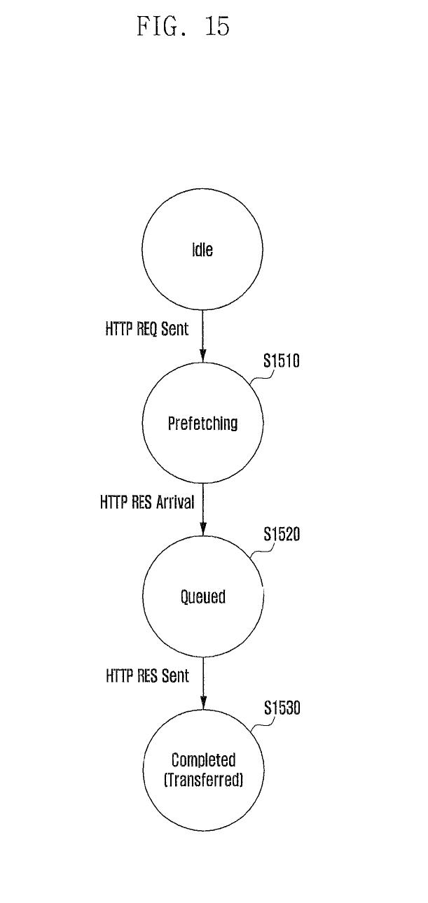

According to at least the second embodiment of the present disclosure, the HTTP session managed by the HTTP proxy server 820 can be in any of the statuses as shown in FIG. 15. FIG. 15 is an example diagram illustrating HTTP session status transitions according to at least the second embodiment of this disclosure. The HTTP proxy server 820, in the stead of the HTTP client 810, can transmit the HTTP REQ message to the HTTP server 830, such that the HTTP session enters the ‘prefetching’ status as denoted by reference number S1510. If the HTTP RES transmitted by the HTTP server 830 arrives at the HTTP proxy server 820, the HTTP session status can transition to the ‘queued’ status as denoted by reference number S1520. Afterward, if the HTTP proxy server 820 sends the corresponding content to the HTTP client 810 in response to the request from the HTTP client 810, the HTTP session status can transition to the ‘completed’ status as denoted by reference number s1530.

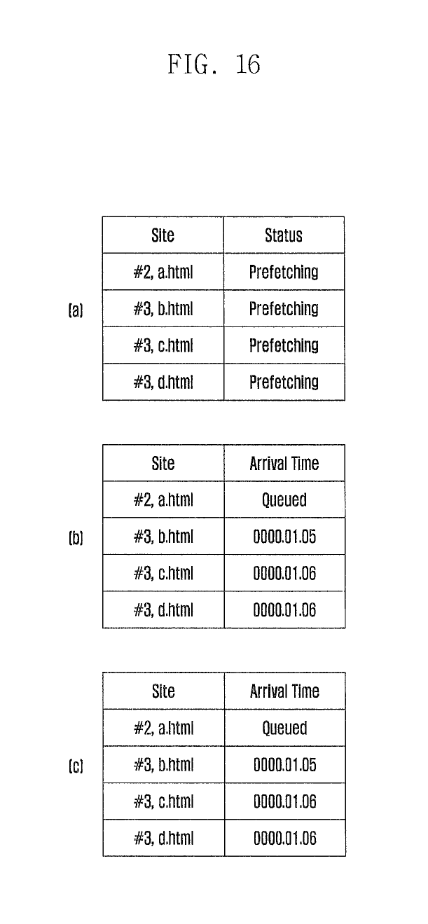

The session information management of the HTTP proxy server 820 is described with reference to FIGS. 14 and 16. FIG. 16 is an example diagram illustrating tables for explaining change of HTTP session information in the embodiment of FIG. 14. In the following, the description is made with reference to the sequences of FIG. 14 and session statuses of FIG. 16. In the case that the resources to access are a.html, b.html, c.html, and d.html; the session statuses can become ‘prefetching’ as shown in part (a) of FIG. 16 after the HTTP REQ messages for all resources are transmitted to the HTTP server 830 at sequence 5, 7, 8, and 9 (S1405, S1407, S1408, and S1409). If the a.html is transmitted by the HTTP server 830 at sequence 13 (S1413) and thus cached in the HTTP proxy server 820, the status of the a.html can be transitioned to ‘queued’ status as shown in part (b). Afterward, if an HTTP REQ message is received at sequence 13 (S1413) and thus the HTTP proxy server 820 forwards the HTTP RES message to the HTTP client 810, the status of the a.html can be transitioned to ‘completed’ status as shown in part (c) of FIG. 16. The statuses of the b.html, c.html, and d.html can be transitioned in the same way as the a.html according to the receipt of the HTTP REQ and RES messages.

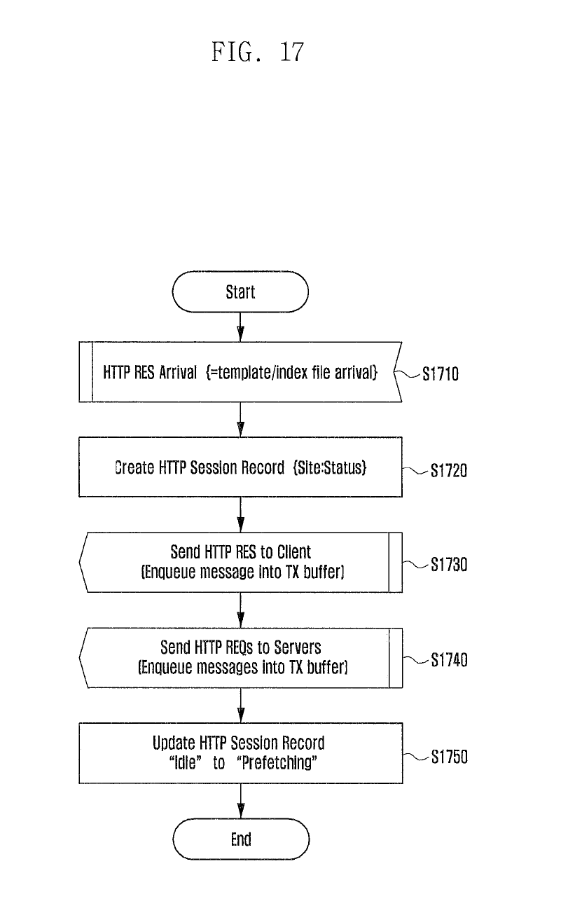

A description can be made of the HTTP REQ message handling procedure of the HTTP proxy server in the second embodiment of the present disclosure. FIG. 17 is an example flowchart illustrating the HTTP REQ message handling procedure of the HTTP proxy server according to at least the second embodiment of this disclosure.

The HTTP proxy server 820 can receive a template or index.html file from the HTTP server 830 at operation S1710. If the HTTP RES message carrying the template or index.html file is received, the HTTP proxy server 820 can generate the HTTP session record including the resource information contained in the template as shown in FIG. 16 at operation S1720. The HTTP proxy server 820 can forward the HTTP RES message to the HTTP client 810 transparently at operation S1730. The HTTP proxy server 820 can generate the HTTP REQ messages to secure the resources indicated in the template in advance at operation S1740. The HTTP proxy server 820 can transition the status of the session carried the HTTP REQ message to ‘prefetching’ status at operation S1750.

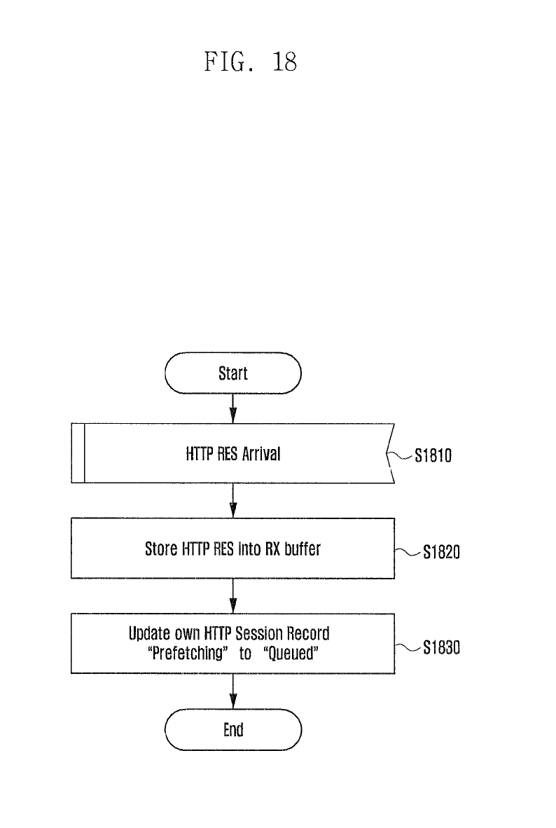

A description is made of the HTTP RES message handling procedure of the HTTP proxy server 820 according to at least the second embodiment of this disclosure. FIG. 18 is an example flowchart illustrating the HTTP RES message handling procedure of the HTTP proxy server according to at least the second embodiment of this disclosure.

If the HTTP RES message carrying the resource information is received from the HTTP server 830 at operation S1810, the HTTP proxy server 820 can store the received information in its cache buffer at operation S1820. The HTTP proxy server 820 can prepare for receiving HTTP REQ messages from the HTTP client and transitions the session status carried the HTTP RES message to the ‘queued’ status at operation S1830.

The third embodiment of the present disclosure is described hereinafter. The third embodiment as an extension of the second embodiment proposes a method of deceiving the HTTP client 810 as if the resources of a specific server are the resources of other servers logically to solve the problem caused by the receipt of the HTTP RES message in an order mismatched to the regular transmission order of HTTP REQ messages when the HTTP client 810 connects to the HTTP servers 830 indicated in the template. That is, the HTTP proxy server 820 can deceive the HTTP client 810 such that the N resources of a server are shown as if they are dispersed in (up to) N different servers, thereby reducing the resource access time delay.

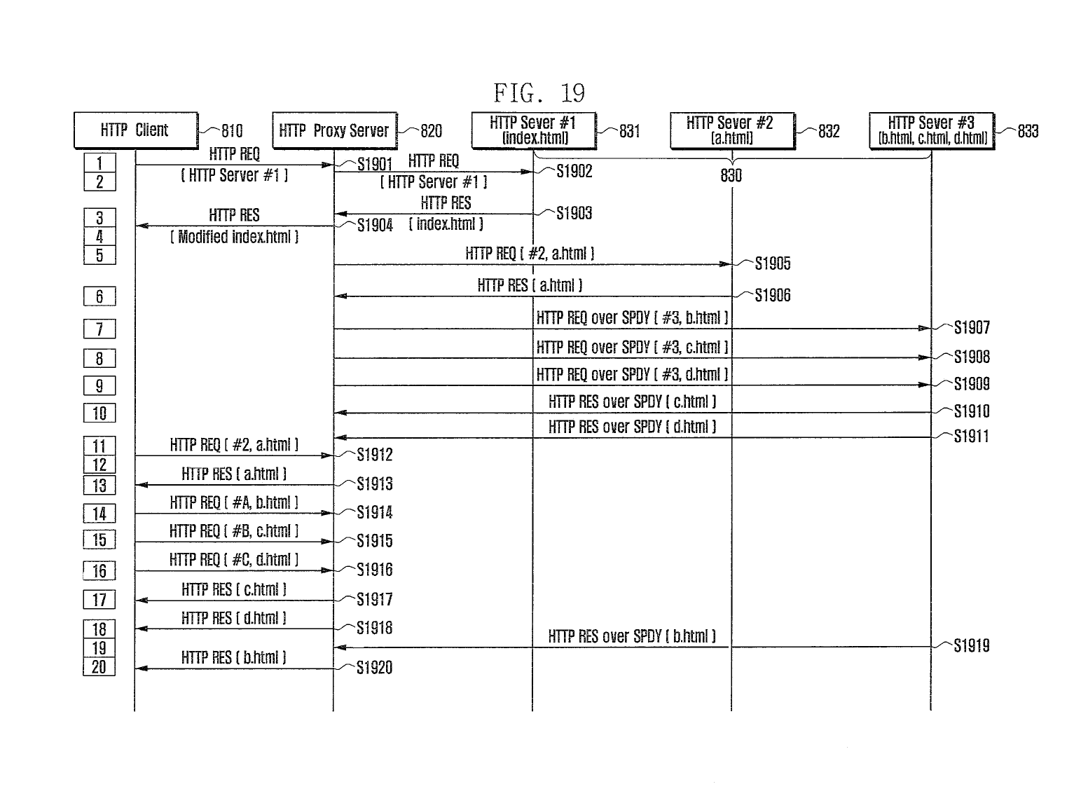

FIG. 19 is an example signal flow diagram illustrating the web contents transmission method according to at least the third embodiment of this disclosure. The HTTP client 801 can transmit an HTTP REQ message to the HTTP server #1 831 via the HTTP proxy server 820 at sequence 1 (S1901 and S1902), and the HTTP server #1 831 can transmit an HTTP RES message including a template file in response to the HTTP REQ message at sequence 3 (S1903 and S1904). The HTTP proxy server 820 can intercept the HTTP RES message and analyze the situation requiring a plurality of resources of a specific server. Then the HTTP proxy server 820 can modify the resource address of the template as if one resource is dispersed in multiple servers at operation S1904. At this time, the resource address transmitted by the HTTP server #1 831 can be changed to private or public addresses available only in the HTTP proxy server 820. The method of the third embodiment operates in such a way of extending the method of the second embodiment. Accordingly, after transmitting the HTTP RES message to the HTTP client 319, the HTTP proxy server 820 can start collecting the resources indicated in the template at sequence 5 (S1905) as in at least the second embodiment. The operations at sequences 5 to 11 are similar to those of the second embodiment. The HTTP proxy server 820 can connect the HTTP server 830 to collect the resources indicated by the template at sequences 5, 7, 8, and (S1905, S1907, S1908, and S1909). Some HTTP RES messages corresponding to the HTTP REQ messages can arrive at sequences 6, 10, 11, (S1906, S1910, and S1911) before the receipt of the initial HTTP REQ message from the HTTP client 810 at sequence 12 (S1912). The HTTP RES message corresponding to the HTTP REQ message (request for a.html) transmitted at sequence 11 (S1912) can arrive at the HTTP client server 810(S1919).

The third embodiment is identical with the second embodiment with the exception that the HTTP REQ messages received from the HTTP client 810 at sequences 14, 15, and 16 (S1914, S1915, and S1916) can be modified such that the addresses of the HTTP server #3 833 as the destination of the messages are changed to #A, #B, and #C as the internal address of the HTTP proxy server 820. Since the messages are transmitted to different addresses, the transmission order of the messages can become meaningless. Accordingly, the HTTP proxy server 820 can be capable of sending the HTTP RES message immediately when the corresponding resource becomes available independently of the transmission order among the HTTP REQ messages. Particularly in the embodiment of FIG. 19, although the HTTP RES message corresponding to the HTTP REQ message (request for b.html) transmitted at sequence 14 (S1914) can arrive at the HTTP proxy server 820 at sequence 19 (S1919), it may not influence the later HTTP REQ message receptions at sequences 15 and 16 (S1915 and S1916) and the HTTP RES message transmissions at sequence 17 and 18 (S1917 and S1918). The HTTP Proxy Server 820 sends HTTP RES message corresponding to the HTTP REQ message (request for b.html) at the operation of S1920.

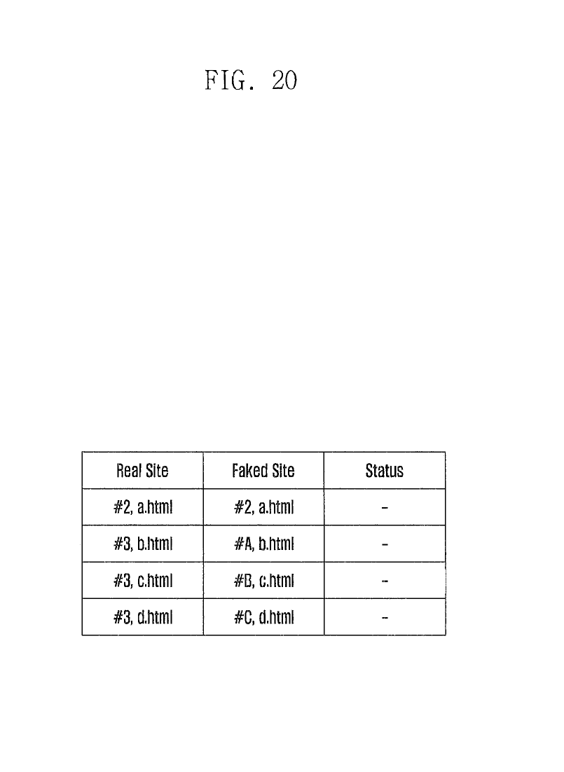

FIG. 20 is an example diagram illustrating a site address mapping table of the HTTP proxy server according to the third embodiment of this disclosure. The HTTP proxy server 820 can manage an address mapping table which maps the real addresses of the resources of the HTTP servers 830 (real sites) and the internal addresses of the HTTP proxy server 820 (faked site) as shown in FIG. 20.

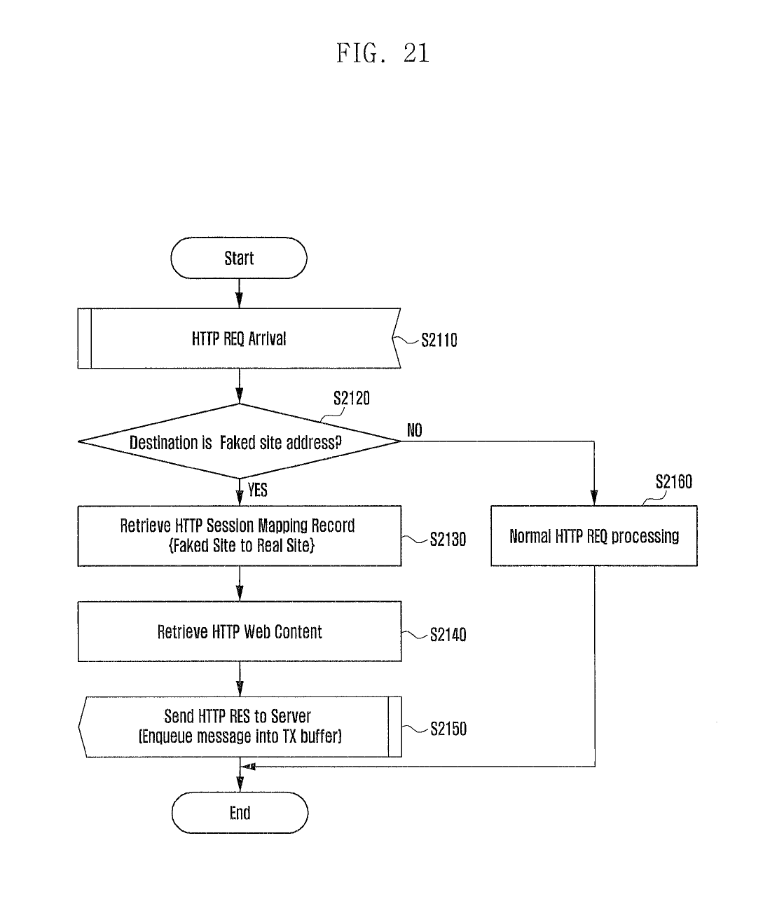

FIG. 21 is an example flowchart illustrating the HTTP REQ message handling procedure of the HTTP proxy server according to at least the third embodiment of this disclosure. If an HTTP REQ message for access to certain resources in association with the session carried the template file, the HTTP proxy server can operate as shown in the flowchart of FIG. 21. The HTTP proxy server 820 can receive an HTTP REQ message at operation S2110. If it is determined that the HTTP REQ message transmitted by the HTTP client 810 for access to the resource has an internal address of the HTTP proxy server 820 as destination at operation S2120, the HTTP proxy server 820 can retrieve the real address mapped to the internal address at operation S2130 and can send the HTTP client the information cached in association with the real address at operations S2140 and S2150. If it is determined that the HTTP REQ messaged transmitted by the HTTP client 810 for access to the resource does not have an internal address of the HTTP proxy server 820 as destination at operation S2120, HTTP proxy server 820 proceed to operation s2160.

The fourth embodiment of the present disclosure is described hereinafter. The fourth embodiment of the present disclosure proposes the operation when the HTTP client 810 and the HTTP proxy server 820 have their own caches. In at least the fourth embodiment, it may be necessary to determine whether the cached contents are available in the course of performing the sequences of FIG. 5. That is, it may be necessary to check the updated time to determine whether the cached data is available in the course of transmitting/receiving HTTP commands associated with the resources indicated in template. In the fourth embodiment of the present disclosure, the template can be extended such that the HTTP server 820 provides at least one of the HTTP clients 810 and HTTP proxy server 820 with the information on the availability of each resource in the template, thereby reducing unnecessary message exchange and improving user's perceived speed.

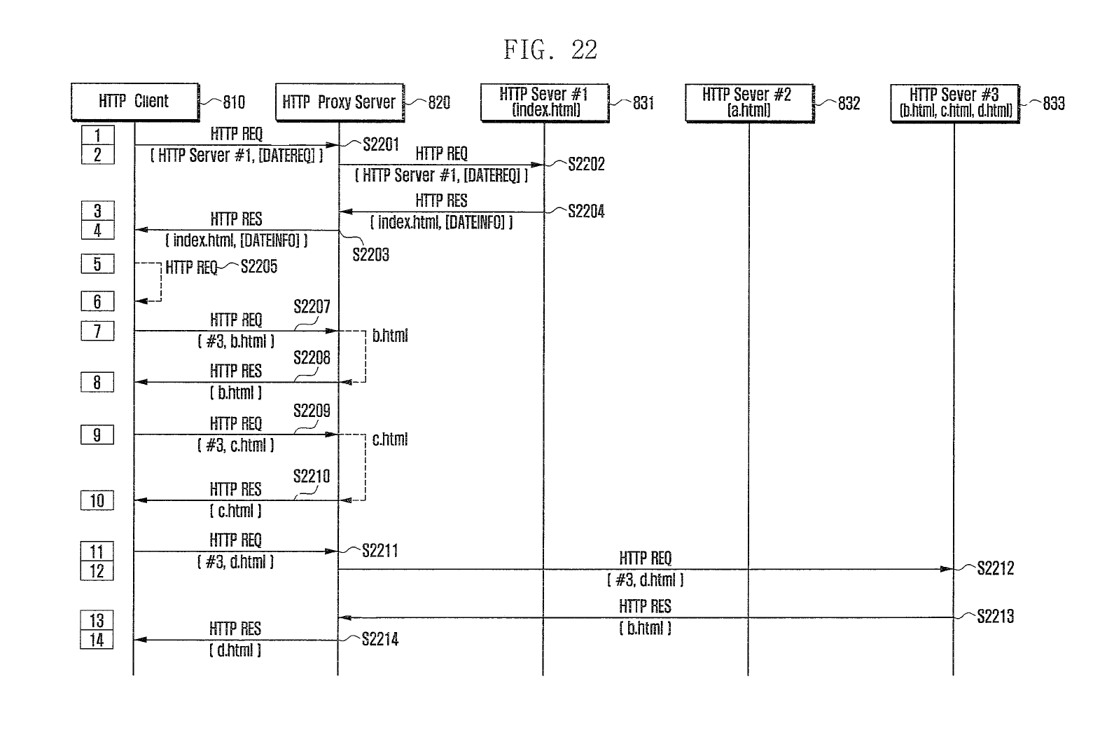

A description is made of the operations of the fourth embodiment of the present disclosure hereinafter with reference to FIG. 22. FIG. 22 is an example signal flow diagram illustrating the web contents transmission method according to at least the fourth embodiment of this disclosure. The HTTP client 810 can send an HTTP REQ message to the HTTP server #1 831 as the representative server of the domain via the HTTP proxy server 820 at sequences 1 and 2 (S2201 and S 2202). At this time, the HTTP client 810 can be aware of the existence of its own cache and can activate a DATEREQ field to notify the HTTP server 830 of the use of the cache. Upon receipt of the HTTP REQ message, if the HTTP proxy server 820 has its own cache and if the HTTP client 810 has activated the corresponding field already, the HTTP proxy server 820 can use the corresponding field as it is and, otherwise if the HTTP client 810 has not use the corresponding field, can activate the corresponding field and then sends the corresponding HTTP REQ message to the HTTP server #1 831 at operation 2202. The HTTP server #1 can send the HTTP RES message including the template and the latest update time of the resources indicated in the template file at sequence 4 (S2204). If the HTTP RES message is received, the HTTP proxy server 820 can determine whether the resources are reusable and, if so, forward the HTTP RES message received from the HTTP server #1 831 to the HTTP client at sequence 3 (S2203). Upon receipt of the HTTP RES message, the HTTP client 810 can determine whether the resources are reusable. Afterward, the HTTP client 810 can read the a.html stored in the cache to present the a.html to the user at operation S2205 and request the HTTP servers 830 for the contents (b.html, c.html, and d.html) absent in its cache at sequences 7, 9, and 11 (S2207, S2209, and S2211). At this time, since the HTTP proxy server 820 knows whether the resource is reusable based on the template received at sequence 3 (S2203), it can send the resources (b.html (s2208) and c.html (s2210)) present in its cache to the HTTP client 810 at sequence 8 and 10 (S2208 and 2210) in response to the HTTP REQ messages transmitted at sequences 7 and 9 (S2207 and S2209). The HTTP proxy server 820 also can bring the resource (d.html, at s2214) requested at sequence 11 (S2211) but absent in its cache from the HTTP server #3 at sequences 12 and 13 (S2212 and S2213).

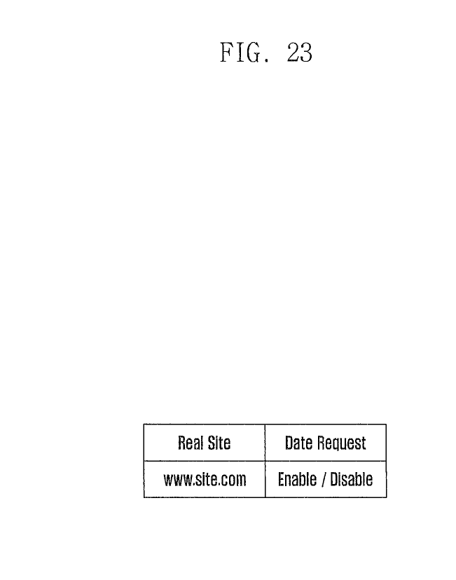

FIG. 23 is an example diagram illustrating a table providing final content access time information added to the HTTP REQ message according to at least the fourth embodiment of this disclosure. In the case that the HTTP client 810 and the HTTP proxy server 820 access the template using the HTTP REQ message, they can request for the time information. In this case, the HTTP client 810 and the HTTP proxy server 820 can activate/deactivate (enable/disable) the data request field as shown in FIG. 23.

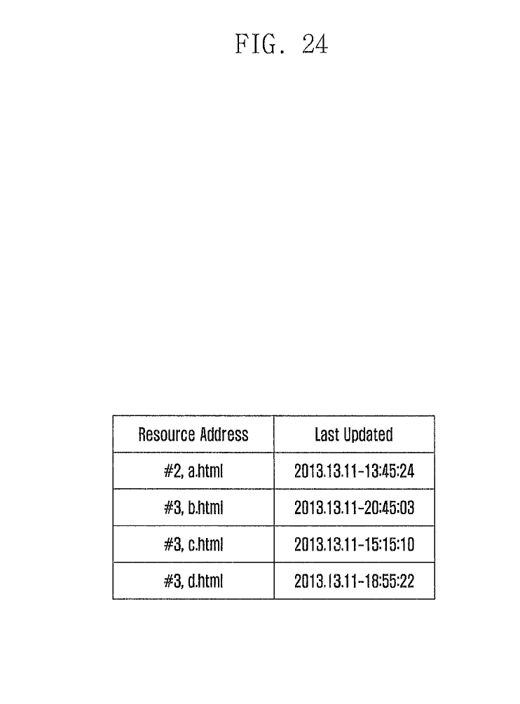

FIG. 24 is an example diagram illustrating a table providing final content update time information added to the HTTP RES message according to at least the fourth embodiment of this disclosure. In the case that the HTTP server 830 can transmit the template file, the HTTP RES message can include the template file along with the resource addresses and the final update time of the corresponding resources as shown in FIG. 24. If the HTTP RES message is received, the HTTP client 810 or the HTTP proxy server 820 can check the times when the corresponding resources have been updated by the HTTP server 830. Accordingly, the HTTP client 810 and the HTTP proxy server 820 having the resources associated with the template file can determine that the information present in their cache is reusable before access to the corresponding resources.

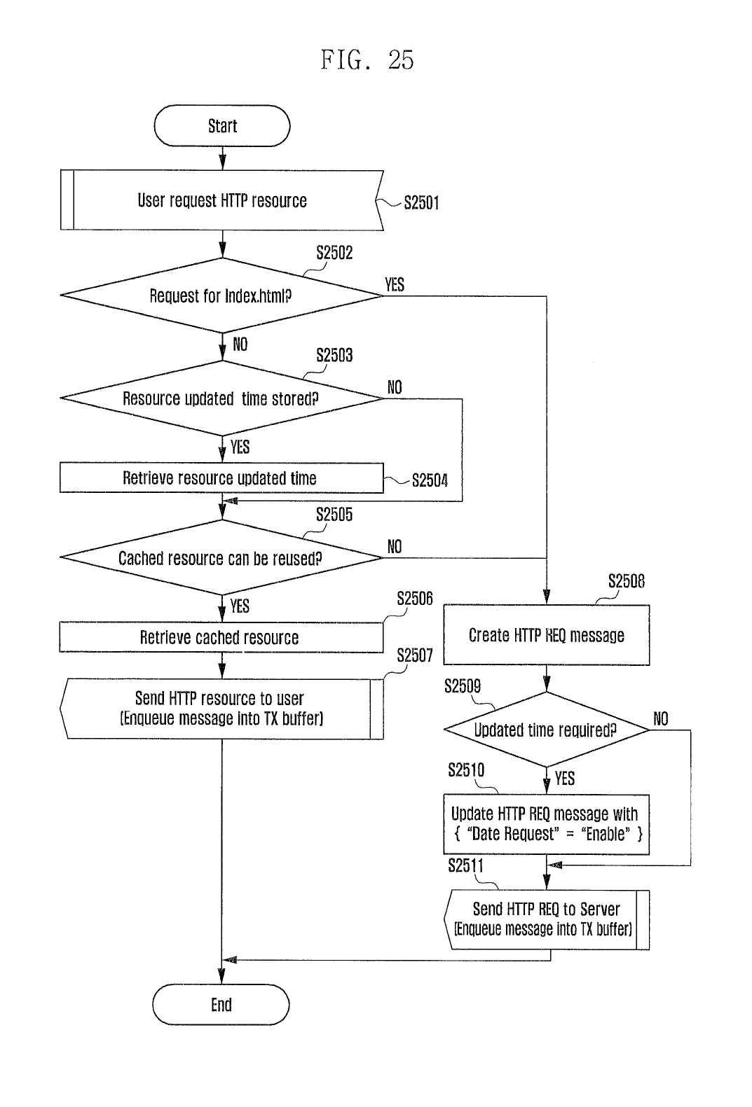

FIG. 25 is an example flowchart illustrating the operation procedure of the HTTP client according to at least the fourth embodiment of this disclosure. The operation of the HTTP client according to at least the fourth embodiment of this disclosure is described with reference to FIG. 25. If a web content access request is input by the content user at operation S2501, the HTTP client 810 can determine whether the request is addressed to the representative server of the domain at operation S2502. If the request is addressed to the representative server of the domain, the HTTP client can send the representative server of the domain an HTTP REQ message including request for the information on the times when the resources forming the template file have been updated through operations S2508, S2509, S2510, and S2511. The HTTP client 810 can determine whether resource update time is stored or not. If the resource update time is stored, the HTTP client 810 can proceed to operation S2504. If there is a request for the resource included in the template file, the HTTP client can retrieve the resource update time at operation S2504 and check the time when the corresponding resource has been stored finally in its cache to determine whether the cached resource can be used at operation S2505. If the cached resource is available, the HTTP client can reuse the corresponding resource at operation S2506 and S2507 and, otherwise if the cached resource unavailable, can transmit the HTTP REQ message for the corresponding resource.

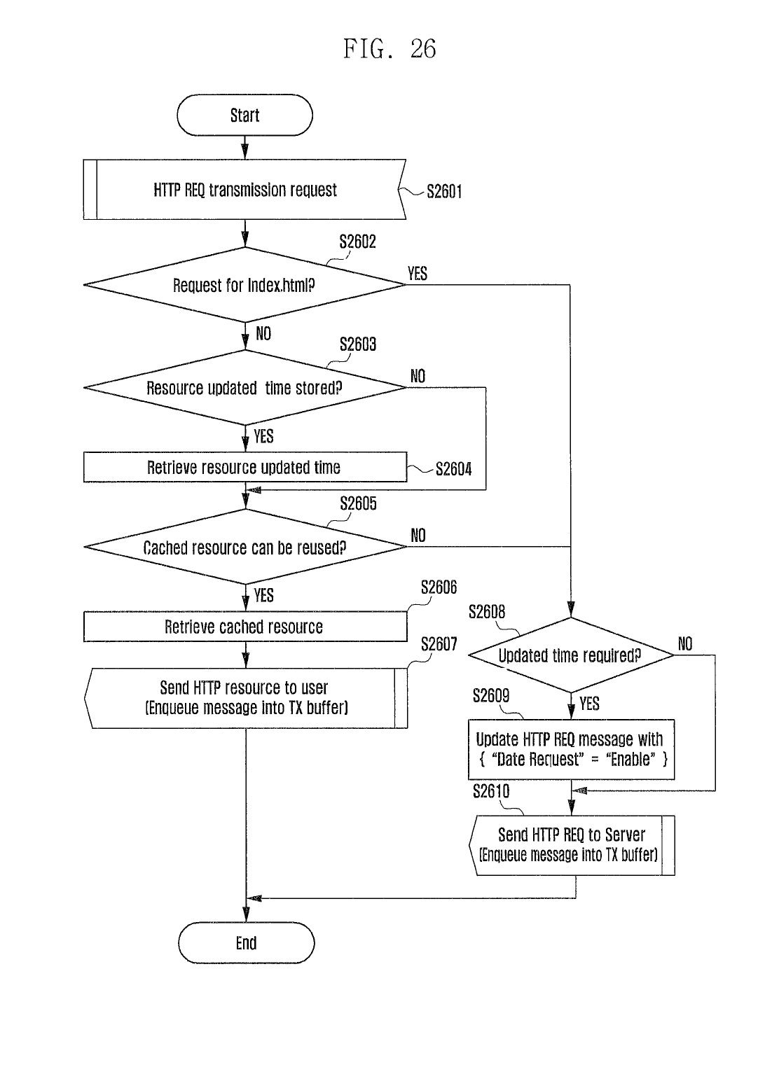

FIG. 26 is an example flowchart illustrating the operation procedure of the HTTP proxy server according to at least the fourth embodiment of this disclosure. The operation of the HTTP proxy server according to at least the fourth embodiment of this disclosure is described with reference to FIG. 26. If an HTTP REQ message is received from the HTTP client 810 at operation S2601, the HTTP proxy server 820 can determine whether the HTTP REQ message is addressed to the representative server of the domain at operation S2602. If the HTTP REQ message is addressed to the representative server of the domain, the HTTP proxy server 820 can determine whether updated time information is required at operation S2608 and, if so, can transmit the HTTP REQ message including the request for the updated time of the resource forming the corresponding template to the representative domain server at operations S2609 and S2610. If the HTTP client 810 requests for the resource in the template file, the HTTP proxy server 820 can check the updated time of the corresponding resource at operation S2603 and the time when the resource has be stored in its cache finally at operation S2604 to determine whether the cached resource can be reused at operation S2605. If the cached resource is reusable, the HTTP proxy server 820 can reuse the resource at operations S2606 and S2607 and, otherwise, send the HTTP server the HTTP REQ message for the corresponding resource.

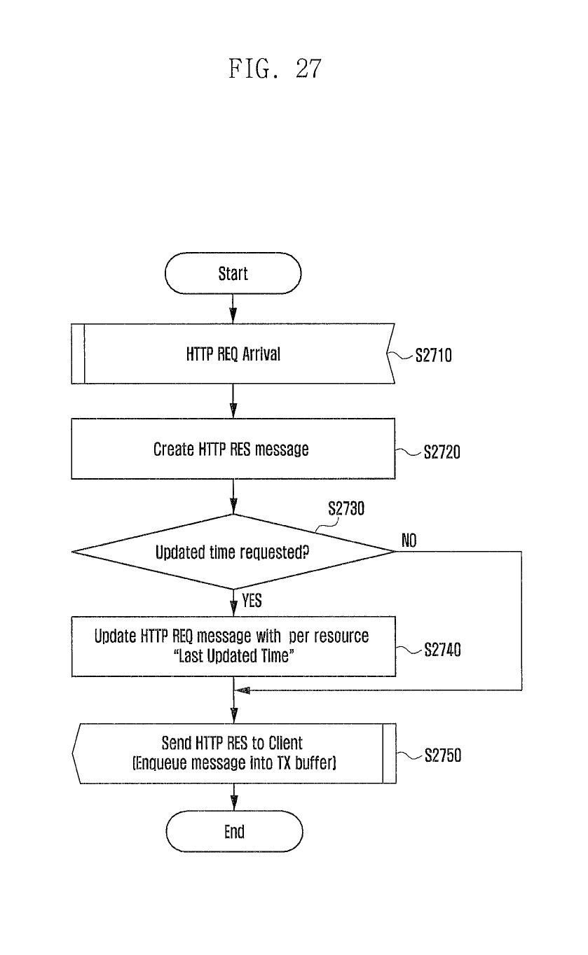

FIG. 27 is an example flowchart illustrating the operation procedure of the HTTP server according to at least the fourth embodiment of this disclosure. The HTTP REQ message handling procedure of the HTTP server 830 in association with the template file is described with reference to FIG. 27. If an HTTP REQ message is received at operation S2710, the HTTP server 830 can generate an HTTP RES message at operation S2720. If it is determined that updated time is requested in the HTTP REQ message at operation S2730, the HTTP server 830 can insert per-resource last updated time into the HTTP RES message at operation S2740 and transmit the HTTP RES message to the HTTP client 810 at operation S2750.

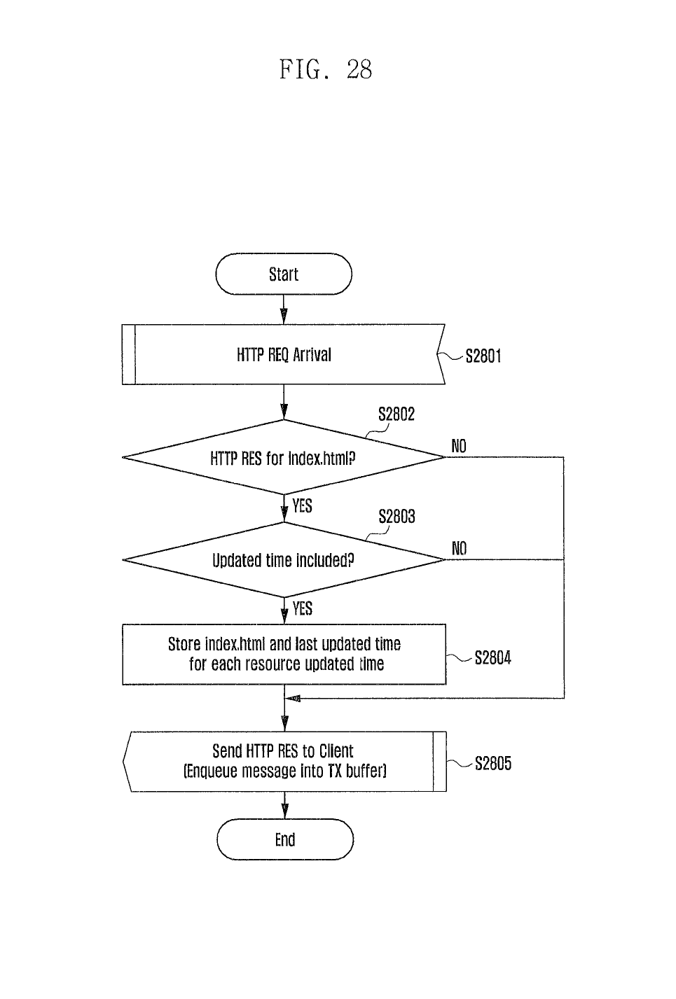

FIG. 28 is an example flowchart illustrating the HTTP RES message handling procedure of the HTTP proxy server according to at least the fourth embodiment of this disclosure. The HTTP RES message handling procedure of the HTTP proxy server according to at least the fourth embodiment of this disclosure is described with reference to FIG. 28. If the HTTP RES message is received at operation S2801, the HTTP proxy server 820 can determine whether the HTTP RES carries a template at operation S2802 and, if so, can determine whether the HTTP RES message includes update time information at operation S2803. If the updated time information is included, the HTTP proxy server 820 can check the information stored in its cache at operation S2804. The HTTP proxy server can send the corresponding HTTP RES message to the HTTP client 810 at operation S2805.

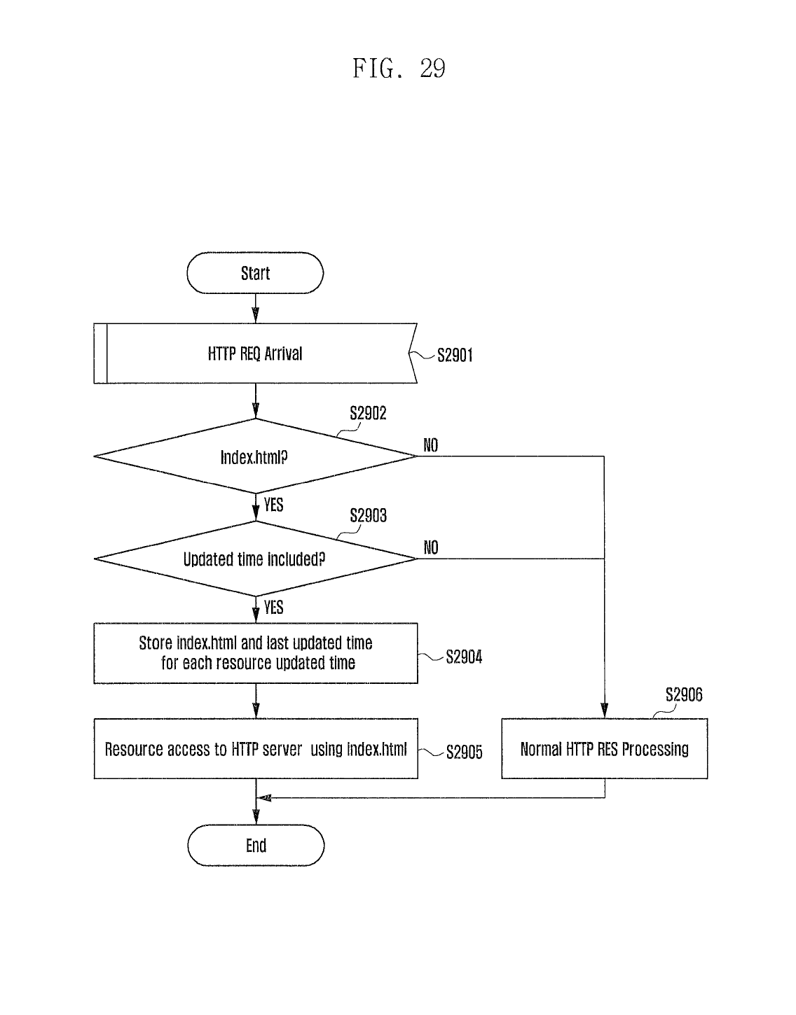

FIG. 29 is an example flowchart illustrating the HTTP RES message handling procedure of the HTTP client according to at least the fourth embodiment of this disclosure. Referring to FIG. 29, the HTTP RES message handling procedure of the HTTP client 810 according to at least the fourth embodiment of this disclosure is described with reference to FIG. 29. If the HTTP RES message is received at operation S2901, the HTTP client 810 can determine whether the HTTP RES carries a template at operation S2902 and, if so, determine whether the updated time is included at operation S2903. The HTTP client 280 can check the updated with and its cache to determine the reuse of the content at operation S2904. The HTTP client 810 can access the resource in the HTTP server using the template at operation S2905. If the HTTP RES message does not carry the template at operation S2902, the HTTP client 810 can handle the HTTP RES message as a normal HTTP RES message at operation S2906.

As disclosed herein, the individual embodiments of the present disclosure can be applicable independently. The individual techniques have been described in the respective embodiments. The present disclosure can be embodied through combination of the techniques proposed in the respective embodiments as well as by applying each technique independently.

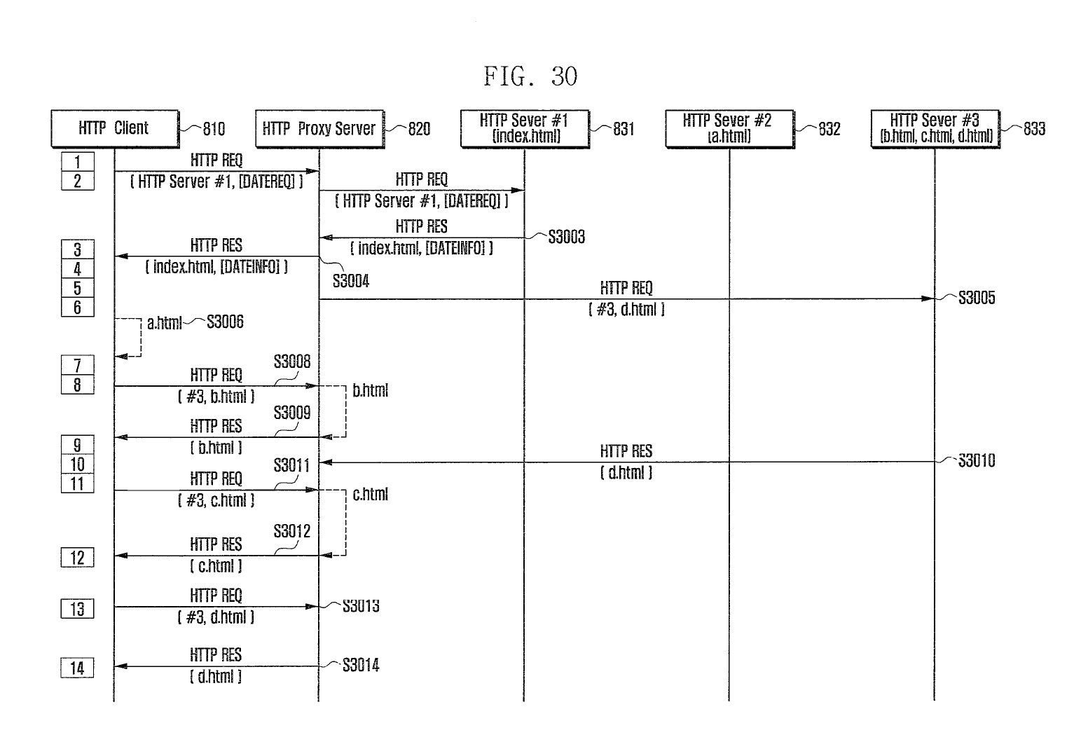

A description is made of the method applying the techniques proposed in the second and fourth embodiments in a combined manner with reference to FIG. 30.

FIG. 30 is an example signal flow diagram illustrating the procedure integrating the operations proposed in the second and fourth embodiments of the present disclosure. The embodiment of FIG. 30 can differ from the embodiment of FIG. 22 in that the HTTP proxy server 820 can request, at operation S3005, the HTTP server 830 for the resource which is absent in its cache and generated after the last version stored in the HTTP client 810 before the receipt of the HTTP REQ request from the HTTP client 81 between sequences 3 and 4 (S3003 and S3004). In order to operate in this way, a part of transmitting the HTTP REQ message containing the time at which the HTTP client 810 has accessed the representative server of the corresponding domain has to be added newly to the method of the fourth embodiment. In at least the embodiment of FIG. 30, the HTTP client 810 can read the a.html which is stored in its case and reusable and present the a.html to the user at operation S3006. The HTTP proxy server 820 can request the HTTP servers 830 for the contents (b.html, c.html, and d.html) absent in its cache at sequences 8, 11, and 13 (S3008, S3011, and S3013). At this time, the HTTP proxy server 820 can know the reusability of the resource present in its cache based on the template received at sequence 3 (S3003), it can send, at the sequences 9 and 12 (S3009 and 3012), the HTTP client 810 the reusable resources (b.html and c.html) requested at sequences 8 and 11 (S3008 and S3011) immediately. The HTTP proxy server 820 also can bring the resource (d.html) absent in its cache or unusable from the HTTP server #3 833 before the request for the d.html from the HTTP client 810 at sequence 10 (S3010). Since the HTTP proxy server 810 can secure the d.html resource at sequence 10 (S3010), it can send the HTTP client 810 the d.html resource immediately at sequence 14 (S3014) in response to the HTTP REQ message requesting for the d.html at sequence 13 (S3013).

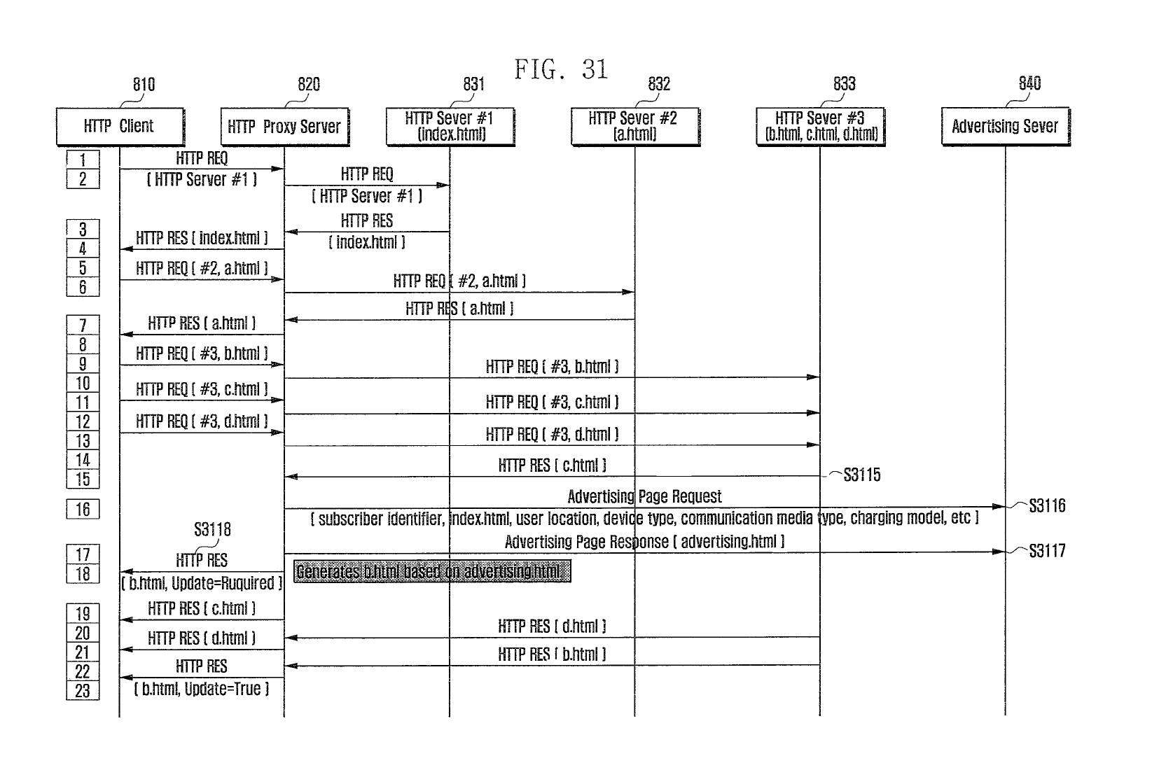

FIG. 31 is an example signal flow diagram illustrating the real time advertisement procedure according to at least the first embodiment of the present disclosure. A dynamic real time advertisement procedure according to the first embodiment of the present disclosure is described with reference to FIG. 31. In FIG. 9 depicting the web contents transmission method according to at least the first embodiment of this disclosure, the HTTP proxy server 820 can send the dummy information in the stead of the delayed content at sequence 16 (S916). In the embodiment of FIG. 31, the dummy information can be replaced with advertisement information. In order to accomplish this, an advertising server can be introduced. This embodiment can aim for the advertising server to send the HTTP client the advertisement contents instead of the dummy information. If an HTTP RES message corresponding to the later HTTP REQ message arrives earlier than those corresponding to the preceding HTTP REQ messages at sequence 15 (S3115), the HTTP proxy server 820 can send the advertising server 840 an advertising page request message at sequence 16 (S3116). If the advertising page request message is received, the advertising server 840 can send the HTTP proxy server 820 an advertising page response message at sequence 17 (S3117). The HTTP proxy server 820 can send the HTTP client 810 the advertising page response message in the stead of the dummy information at sequence 18 (S3118). Afterward, the resource request and response messages exchange can be performed in the same manner as the procedure of FIG. 9. In an embodiment, the HTTP proxy server 820 can send the advertising server the user information to perform user-specific advertisement. The user information can include subscriber identifier, representative domain server template file, device type, communication technology (such as WLAN and cellular communication network), subscriber billing model, and the like

As described above, the web contents transmission method and apparatus of the present disclosure can be advantageous in terms of improving the user's perceived web contents transmission speed.

Also, the web contents transmission method and apparatus of the present disclosure can be advantageous in terms of user's web content consumption satisfaction by minimizing transmission delay of contents provided by the HTTP servers.

Also, the web contents transmission method and apparatus of the present disclosure can be advantageous in terms of improving the user's perceived web content transmission speed in such a way that an HTTP proxy server stores the contents of the HTTP server(s) in advance and delivers the contents requested by the HTTP client immediately even when there is network delay between the HTTP client and servers.

Also, the web contents transmission method and apparatus of the present disclosure can be advantageous in terms of improving the user's perceived web content transmission speed in such a way of removing probability of extra delay caused by reordering of transmission/receptions of resources and transmitting the resources simultaneously as if multiple servers provide the a single resource even when one server provides multiple resources.

Furthermore, the web contents transmission method and apparatus of the present disclosure can be advantageous in terms of improving the user's perceived web content transmission speed in such a way that the HTTP client and the HTTP proxy server determine whether to reuse resources at a template file level without extra message exchange.

Although the present disclosure has been described with an exemplary embodiment, various changes and modifications can be suggested to one skilled in the art. It is intended that the present disclosure encompass such changes and modifications as fall within the scope of the appended claims.

What is claimed is:

1. A web contents transmission method of a Hypertext Transfer Protocol (HTTP) proxy server, the method comprising:
receiving an HTTP Request (REQ) message from an HTTP client;
transmitting the HTTP REQ message including an updated time information provision request for resource included in a template file of a domain;
receiving an HTTP Response (RES) message corresponding to the HTTP REQ message from the HTTP server, the HTTP RES message including updated time information on at least one of the resources included in the template file of the domain; and
processing a new HTTP REQ message from the HTTP client based on the update time information.

2. The method of claim 1, wherein the processing of the new HTTP REQ message comprises:
transmitting, when the resource requested with the new HTTP REQ message is present in a cache and reusable based on the update time information, the cached resource to the HTTP client; and
transmitting, when the resource requested with the new HTTP REQ message is absent in the cache or unusable, the resource acquired by requesting the HTTP server to the HTTP client.

3. The method of claim 2, further comprising:
determining whether the cached resource is reusable before receiving the new HTTP REQ message;
comparing a last update time of the resource included in the HTTP RES message and a last cached time of the resource; and
determining, when the last cached time of the resource is later than the last update time, that the resource is reusable.

4. The method of claim 1, further comprising determining, when the received HTTP REQ message is of requesting the template file of the domain, whether updated time information is necessary,
wherein the transmitting of the HTTP REQ message comprises adding the updated time information provision request to the received HTTP REQ message.

5. The method of claim 4, wherein the determining of whether the updated time information is necessary comprises determining, when the resource about the domain is stored in the cache and the HTTP REQ message received from the HTTP client includes no updated time information provision request on the resource of the domain, that the time updated time information is necessary.

6. A Hypertext Transfer Protocol (HTTP) proxy server comprising:
a communication unit configured to communicate with an HTTP client and HTTP server;
a storage unit configured to store data transmitted/received by the communication unit; and
a control unit configured to control receiving an HTTP Request (REQ) message from an HTTP client, transmitting the HTTP REQ message including an updated time information provision request for resource included in a template file of a domain, receiving an HTTP Response (RES) message corresponding to the HTTP REQ message from the HTTP server, the HTTP RES message including updated time information on at least one of the resources included in the template file of the domain, and processing a new HTTP REQ message from the HTTP client based on the update time information.

7. The HTTP proxy server of claim 6, wherein the control unit is configured to control transmitting, when the resource requested with the new HTTP REQ message is present in a cache and reusable based on the update time information, the cached resource to the HTTP client and transmitting, when the resource requested with the new HTTP REQ message is absent in the cache or unusable, the resource acquired by requesting the HTTP server to the HTTP client.

8. The HTTP proxy server of claim 7, wherein the control unit is configured to determine whether the cached resource is reusable before receiving the new HTTP REQ message, compare last update time of the resource included in the HTTP RES message and last cached time of the resource, and determine, when the last cached time of the resource later than the last update time, that the resource is reusable.

9. The HTTP proxy server of claim 6, wherein the control unit is configured to determine, when the received HTTP REQ message is of requesting the template file of the domain, whether updated time information is necessary and adds the updated time information provision request to the received HTTP REQ message.

10. The HTTP proxy server of claim 9, wherein the control unit is configured to determine, when the resource about the domain is stored in the cache and the HTTP REQ message received from the HTTP client includes no updated time information provision request on the resource of the domain, that the time updated time information is necessary.

11. A web contents transmission method of a Hypertext Transfer Protocol (HTTP) client, the method comprising:
receiving an input of an HTTP resource request for a certain domain;
transmitting an HTTP request (REQ) message including an updated time information provision request for resource included in a template file of the domain;
receiving an HTTP Response (RES) message corresponding to the HTTP REQ message from the HTTP server, the HTTP RES message including updated time information on at least one of the resources included in the template file of the domain; and
processing a new HTTP resource request based on the updated time information.

12. The method of claim 11, the processing of the new HTTP resource request comprising:
processing, when the resource requested by the input of the new HTTP resource request is present in a cache and reusable based on the update time information, to reuse the resource stored in the cache;
requesting, when the resource requested by the input of the new HTTP resource request is absent in a cache and unusable based on the update time information, one of the HTTP server and HTTP proxy server for the information on the corresponding resource; and
receiving the resource from one of the HTTP server and HTTP proxy server.

13. The method of claim 12, further comprising:
determining whether the cached resource is reusable before receiving the new HTTP REQ message;
comparing last update time of the resource included in the HTTP RES message and last cached time of the resource; and
determining, when the last cached time of the resource later than the last update time, that the resource is reusable.

14. A Hypertext Transfer Protocol (HTTP) client, comprising:
a communication unit configured to communicate with at least one of an HTTP server and a HTTP proxy server; and
a communication unit configured to control receiving an input of an HTTP resource request for a certain domain, transmitting an HTTP request (REQ) message including an updated time information provision request for resource included in a template file of the domain, receiving an HTTP Response (RES) message corresponding to the HTTP REQ message from the HTTP server, the HTTP RES message including updated time information on at least one of the resources included in the template file of the domain, and processing a new HTTP resource request based on the updated time information.

15. The HTTP client of claim 14, wherein the control unit is configured to control processing, when the resource requested by the input of the new HTTP resource request is present in a cache and reusable based on the update time information, to reuse the resource stored in the cache, requesting, when the resource requested by the input of the new HTTP resource request is absent in a cache and unusable based on the update time information, one of the HTTP server and HTTP proxy server for the information on the corresponding resource, and receiving the resource from one of the HTTP server and HTTP proxy server.

16. The HTTP client of claim 15, wherein the control unit is configured to determine whether the cached resource is reusable before receiving the new HTTP REQ message, compare last update time of the resource included in the HTTP RES message and last cached time of the resource, and determine, when the last cached time of the resource later than the last update time, that the resource is reusable.

17. The method of claim 1, further comprising if the HTTP REQ message is addressed to the representative server of the domain, the HTTP proxy server determines whether updated time information is required.

18. The method of claim 17, further comprising if the HTTP proxy server determines whether updated time information is required, the HTTP proxy server transmits the HTTP REQ message including the request for the updated time of the resource forming the corresponding template to the representative domain server.

19. The method of claim 18, further comprising if the HTTP client requests for the resource in the template file, the HTTP proxy server checks the updated time of the corresponding resource.

20. The method of claim 19, further comprising storing the corresponding resource in a cache to determine whether the cached resource can be reused.
